(19) United States
(12) Patent Application Publication
(10) Pub. No.: US 2026/0369037 A1
(43) Pub. Date: Nov. 19, 2026

(54) CLASSIFYING MULTI-PART OBJECTS IN DIGITAL IMAGES USING PART-BASED DESCRIPTION MATCHING

(71) Applicants: Adobe Inc., San Jose, CA (US); Auburn University, Auburn, AL (US)

(72) Inventors: Thang M Pham, Auburn, AL (US); Peijie Chen, San Francisco, CA (US); Thanh Tin Nguyen, Auburn, AL (US); Seunghyun Yoon, Seoul (KR); Trung Bui, San Jose, CA (US); Anh Totti Nguyen, Auburn, AL (US)

(21) Appl. No.: 19/210,962

(22) Filed: May 16, 2025

(51) Int. Cl. G06V 10/764; G06V 10/25; G06V 10/74; G06V 10/82; G06V 10/94; G06V 20/70

(52) U.S. Cl. CPC G06V 10/764; G06V 10/25; G06V 10/761; G06V 10/82; G06V 10/945; G06V 20/70

(57) ABSTRACT

The present disclosure relates to systems, non-transitory computer-readable media, and methods for determining a classification of a multi-part object within a digital image by linking textual descriptors of object parts to portions of the digital image. For example, the disclosed systems generate, utilizing an image encoder, an image embedding representing a digital image comprising a multi-part object. In some embodiments, the disclosed systems select, from the image embedding, a set of visual part embeddings representing visual parts of the multi-part object that correspond to text embeddings representing names of a plurality of parts corresponding to the multi-part object. The disclosed systems generate, utilizing a part neural network layer with descriptor embedding matching, a classification of the multi-part object according to relationships between the set of visual part embeddings selected from the image embedding and a set of descriptor embeddings representing textual descriptions of the plurality of parts for the classification.

### BACKGROUND

The classification of objects within a digital image (e.g., fine-grained classification) is a long-standing computer vision challenge. Specifically, improvements to image processing techniques have made it possible to analyze digital images and detect various classes of objects (and their positions) in digital images. Given the complexity and varied nature of objects and their depictions in digital images, accurately determining detailed classifications (e.g., sub-classes) of certain classes of objects is often challenging. For example, some classes of objects such as animals (e.g., birds or dogs) have many different related classes or sub-classes (e.g., species of birds/dogs) that are often difficult to differentiate in digital images via image processing techniques. Current classification systems offer limited, inefficient tools for accurately detecting detailed classifications of objects.

### SUMMARY

One or more embodiments described herein provide benefits and/or solve one or more of the foregoing or other problems in the art with systems, methods, and non-transitory computer-readable media for fine-grained classification of a multi-part object within a digital image. To illustrate, in one or more embodiments, the disclosed systems generate visual part embeddings that map relationships between object part names and detected object parts of a multi-part object within a digital image. In one or more cases, the disclosed systems further introduce processes for predicting bounding boxes-displayed within the digital image-that indicate locations of the object parts of the multi-part object, where the locations of the object parts correspond to the set of visual part embeddings. In various embodiments, the disclosed systems, by utilizing a part neural network layer with part-level matching, generate a predicted classification by determining relationships between visual part embeddings and textual part descriptors that correspond to a plurality of classes. Furthermore, in some cases, the disclosed systems generate a new class for the multi-part object by facilitating the editing of textual part descriptors via a graphical user interface.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

This disclosure will describe one or more embodiments of the invention with additional specificity and detail by referencing the accompanying figures. The following paragraphs briefly describe those figures.

FIG. 1 illustrates a diagram of an environment in which an editable classification system operates in accordance with one or more embodiments.

FIG. 2 illustrates an overview diagram of the editable classification system generating a predicted label for a multi-part object in an input image in accordance with one or more embodiments.

FIG. 3 illustrates a diagram of the editable classification system generating a predicted label for a multi-part object in an input image from selected visual part embeddings in accordance with one or more embodiments.

FIG. 4 illustrates a diagram of the editable classification system generating visual part embeddings that map relationships between object part names and image patches in accordance with one or more embodiments.

FIG. 5 illustrates a diagram of the editable classification system generating an annotated image and a classification of a multi-part object accordance with one or more embodiments.

FIG. 6 illustrates a diagram of the editable classification system generating a new class for a classifier neural network by editing textual descriptors in accordance with one or more embodiments.

FIG. 7 illustrates a diagram of the editable classification system training neural network layers by contrastive training between object parts and textual descriptors in accordance with one or more embodiments.

FIGS. 8A-8C illustrate diagrams of the editable classification system jointly training a linear projection layer and a box neural network layer in accordance with one or more embodiments.

FIGS. 9A-9B illustrate diagrams of the editable classification system and a conventional system generating a classification for a multi-part object in accordance with one or more embodiments.

FIG. 10 illustrates a diagram of the editable classification system providing rationale for rejecting a class in classifying a multi-part object in accordance with one or more embodiments.

FIGS. 11A-11B illustrate diagrams of a graphical user interface classifying a multi-parti object according to user input in accordance with one or more embodiments.

FIG. 12 illustrates a diagram of a graphical user interface presenting bounding boxes linked to textual descriptors according to user input in accordance with one or more embodiments.

FIG. 13 illustrates a schematic diagram of the editable classification system in accordance with one or more embodiments.

FIG. 14 illustrates a flowchart of a series of acts for generating a classification of a multi-part object in accordance with one or more embodiments.

FIG. 15 illustrates a block diagram of an example computing device for implementing one or more embodiments of the present disclosure.

### DETAILED DESCRIPTION

This disclosure describes one or more embodiments of an editable classification system that determines a classification of a multi-part object within a digital image by linking editable textual descriptors of object parts to portions of the digital image corresponding to the object parts. Specifically, in some embodiments, the editable classification system selects visual part embeddings that map the relationship between object part names and portions of a digital image comprising a multi-part object. For example, the editable classification system generates and displays a set of bounding boxes, from the visual part embeddings, that visually indicate the location of object parts of the multi-part object within the digital image. The editable classification system also determines relationships between the visual part embeddings of the digital image and textual part descriptors that describe the object parts of a plurality of known classes. The editable classification system uses part-level matching, via a multi-part object classifier, to generate a classification of the multi-part object by determining similarities between the visual part embeddings and subsets of the textual part descriptors. In some embodiments, the editable classification system generates a new class for the multi-part object classifier without further training of the multi-part object classifier via by modifying textual descriptors.

As just mentioned, in some embodiments, the editable classification system selects visual part embeddings by determining relationships between object part names and portions (e.g., patches) of a digital image comprising a multi-part object. Specifically, in some cases, the editable classification system utilizes a text encoder to generate text embeddings from text indicating object part names that describe one or more typical parts of a multi-part object within a particular domain (e.g., different parts of a bird or animal). Additionally, in various embodiments, the editable classification system generates patch embeddings by processing, via an image encoder, a digital image comprising a multi-part object. Furthermore, in one or more cases, the editable classification system selects visual part embeddings that indicate locations of the digital image that illustrate parts of the multi-part object corresponding to the object part names by determining relationships (or similarities) between the patch embeddings and text embeddings.

In some embodiments, the editable classification system generates a set of bounding boxes for display within a digital image that visually indicate object part locations of the multi-part object. In various cases, the editable classification system generates a contextualized embedding, from the visual part embeddings, indicating spatial information for object parts of the multi-part object within the digital image. For example, the editable classification system, utilizing a box neural network layer (e.g., a box MLP), predicts a set of bounding boxes corresponding to the visual part embeddings and displays the bounding boxes within the digital image comprising the multi-part object.

In one or more embodiments, the editable classification system generates a classification of the multi-part object, via a multi-part object classifier, according to relationships between the visual part embeddings and the textual part descriptors. For example, the editable classification system, by utilizing a part neural network layer, determines relationships (e.g., similarity scores) between the visual part embeddings and the textual part descriptors to determine a likelihood that the multi-part object belongs to a class represented by a subset of textual part descriptors. Furthermore, in some cases, the editable classification system generates a classification (e.g., a predicted label) of the multi-part object by comparing similarity scores between the digital image of the multi-part object and subsets of textual descriptors related to known classes.

In some cases, the editable classification system generates a classification for the multi-part object by generating a new class. For example, the editable classification system, via a graphical user interface, modifies the text of one or more textual descriptors of the closest-matching known class to generate a new class. In various embodiments, the editable classification system utilizes modified textual descriptors, in combination with text indicating the name of the new class, to add a new class without further training of the multi-part object classifier.

As suggested above, many conventional systems exhibit a number of shortcomings or disadvantages, particularly in efficiently determining a classification of a multi-part object within a digital image. To elaborate, some existing vision-language systems rely on Term Frequency Inverse Document Frequency (“TF-IDF”) to match visual part embeddings to text embeddings, which treats each word as independent and ignores word order or context. Additionally, TF-IDF is sparse and high-dimensional, leading to memory inefficiency and poor scalability. In some cases, vision-language systems that match visual part embeddings to text embeddings (such as those utilizing TF-IDF), require a separate trained model to detect object parts of a multi-part object, further incurring computational costs.

Additionally, some conventional vision-language classifiers (e.g., Attribute-Label Embedding) employ a fixed set of attributes and train a weight matrix for zero-shot classification. However, various such conventional systems require tabular data annotations for every new class in the dataset, editing in the weight matrix, and model retraining. As such, some of these conventional systems require significant computational resources when adding a new class to a set of existing (or known) classes.

Due at least in part to their inefficiencies, many prior systems are also inaccurate. Some current systems, while capable of identifying objects when provided with a class name, perform poorly when such class names are removed or replaced by less common ones. For example, some CLIP-based classifiers rely on a prompt containing a class name known to the text encoder and thus provide inaccurate classifications if the class name of an object in an image is not provided or is currently unknown. In addition, in some conventional systems, textual concepts are compared against an entire image for classification, making it unknown what image details match a given descriptor. In some such cases, the unavailability of image detail mapping renders it difficult to identify errors in the rationale of the model, thus perpetuating inaccuracies.

In addition to problems of inefficiencies and inaccuracy, conventional vision-language systems also experience problems of operational inflexibility. For example, various current vision-language systems that claim to be explainable by comparing the input image with a set of learned, part prototypes (e.g., image patches) or natural-language concepts (e.g., textual but at the image level) generate part prototypes as feature vectors. In such systems, the feature vectors are fixed and thus cannot incorporate new classes without retraining. Furthermore, some current systems, in order to classify a multi-part object within a digital image, require training set images in a supervised-learning setting or demonstration images in a zero-shot setting to classify an image, which is impractical and rigid when building a classifier for a novel species whose photos do not yet exist in the database.

Additionally, some conventional vision-language classifiers require the prompt to have a known class name (e.g., a special code instead of an expressive, natural description) that matches the input image. In various conventional vision-language systems, the conventional systems proport to be interpretable since textual concepts are utilized in prompts. However, some conventional systems that rely on these class-wise differential captions or learned concept weights operate at the image level, thus generating a rigid description of an image as a whole.

As suggested, one or more embodiments of the editable classification system improve conventional systems. For example, in one or more embodiments, the editable classification system improves computational efficiency and speed over current systems. In some cases, by utilizing an editable interface, the editable classification system enables users to add an unseen class to the system without retraining of the system. For instance, users only need to provide a textual description of each object part of a multi-part object in natural language to add a new class to a database of known classes. As the editable classification system, in various embodiments, does not require training-set images or demonstration images to add a new class, the editable classification system streamlines the addition of new classes and reduces the necessary computational resources.

Relatedly, as mentioned, embodiments of the editable classification system improve accuracy over prior systems, particularly in regard to determining a classification of a multi-part object within a digital image. As discussed previously, in some embodiments, the editable classification system relies on textual descriptors matched to specific pixels of a digital image representing object parts of a multi-part object. Specifically, the editable classification system, in various cases, provides textual descriptions linked to bounding boxes indicating objects parts within a digital image, enabling users to observe and edit the object attributes that contribute to each final position without any further training. As the editable classification system, in one or more embodiments, allows users to correct and/or update textual descriptors linked with object parts of a multi-part object, the editable classification system improves its accuracy in identifying a class corresponding to the multi-part object. Furthermore, matching the textual descriptors to individually identified, common parts of multi-part objects provides improved classification of multi-part objects from a plurality of related classes or sub-classes.

Additionally, in one or more cases, the editable classification system builds a classifier for a novel species whose photos do not yet exist in the database, thus accurately classifying a novel species. For example, the editable classification system selects a class closest to those stored within the training database (e.g., known classes), allows a user to edit the corresponding textual descriptors, and then saves the updates textual descriptors along with text indicating a name of the new class as a new class. Thus, in various cases, by utilizing an editable graphical user interface, the editable classification system provides an accurate classification of a multi-part object within a digital image that contains a previously unseen class.

Similarly, embodiments of the editable classification system improve operational flexibility of computing systems for classifying multi-part objects within digital images. In some embodiments, the editable classification system, by facilitating ante-hoc editing of textual descriptors linked to object parts of a multi-part object, allows for flexible addition of new classes to a class database. For example, the editable classification system visually displays bounding boxes within a digital image indicating object parts of a multi-part object and associated editable textual descriptions of the object parts to modify textual descriptors of a class. Additionally, in these or other embodiments, the editable classification system allows for modifications of a known class by updating textual descriptors of a class according to user modifications of the textual descriptors within a graphical user interface without requiring retraining of the editable classification system. Thus, the editability of known classes and the flexible addition of unknown classes provides flexibility in how the editable classification system classifies a multi-part object within a digital image.

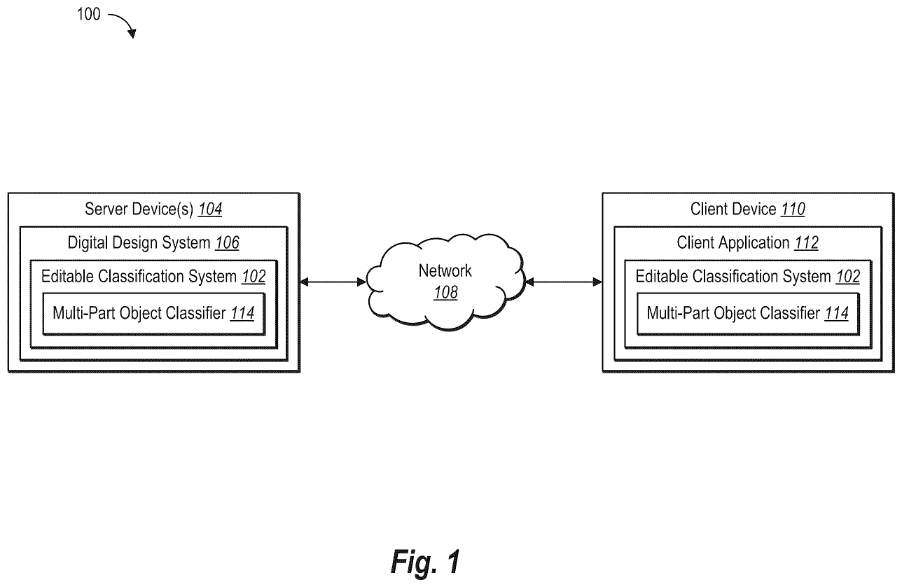

Additional detail regarding the editable classification system will now be provided with reference to the figures. For example, FIG. 1 illustrates a schematic diagram of an example system environment 100 for implementing an editable classification system 102 in accordance with one or more embodiments. An overview of the editable classification system 102 is described in relation to FIG. 1. Thereafter, a more detailed description of the components and processes of the editable classification system 102 is provided in relation to the subsequent figures.

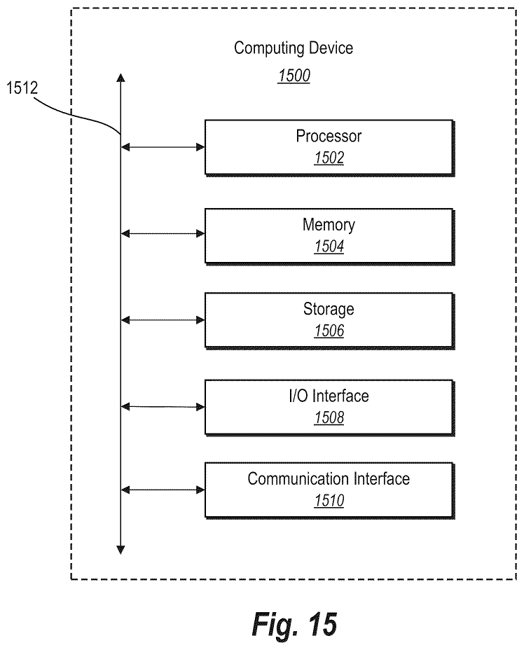

As shown, the system environment 100 includes server device(s) 104, a client device 110, a network 108, and a multi-part object classifier 114. Each of the components of the system environment 100 communicate via the network 108, and the network 108 is any suitable network over which computing devices communicate. Example networks are discussed in more detail below in relation to FIG. 15.

As mentioned, the system environment 100 includes a client device 110. The client device 110 is one of a variety of computing devices, including a smartphone, a tablet, a smart television, a desktop computer, a laptop computer, a virtual reality device, an augmented reality device, or another computing device as described in relation to FIG. 15. Although FIG. 1 illustrates a single instance of the client device 110, in some embodiments, the system environment 100 includes multiple different client devices, each associated with a different user. The client device 110 communicates with the server device(s) 104, the multi-part object classifier 114, and/or the digital design system 106 via network 108. For example, the client device 110 receives information from the server device(s) 104 and provides information to server device(s) 104 relating to the classification of a multi-part object within a digital image.

As shown in FIG. 1, the client device 110 includes a client application 112. In particular, the client application 112 is a web application, a native application installed on the client device 110 (e.g., a mobile application or a desktop application), or a cloud-based application where all or part of the functionality is performed by the server device(s) 104. The client application 112 presents or displays information to a user, including a graphical user interface for classifying a multi-part object within a digital image (e.g., via the multi-part object classifier 114).

As also illustrated in FIG. 1, the system environment 100 includes the server device(s) 104. The server device(s) 104 generates, tracks, stores, processes, receives, and transmits electronic data, such as text related to one or more contextual parameters of the digital design editing workflow. For example, the server device(s) 104 receives data from the client device 110 in the form of a digital image including a multi-part object for classification (e.g., via the multi-part object classifier 114). In response, the server device(s) 104 provides data to the client device 110 in the form of textual descriptors linked to bounding boxes displayed within the digital image, as described herein.

In some embodiments, the server device(s) 104 communicates with the client device 110 to transmit and/or receive data via the network 108. In some embodiments, the server device(s) 104 comprises a distributed server where the server device(s) 104 includes a number of server devices distributed across the network 108 and located in different physical locations. The server device(s) 104 comprise a content server, an application server, a communication server, a web-hosting server, a multidimensional server, or a machine learning server.

As further shown in FIG. 1, the server device(s) 104 also includes the editable classification system 102 as part of a digital design system 106. For example, in one or more implementations, the digital design system 106 stores, generates, modifies, edits, enhances, and/or digital content, such as classifications of multi-part objects within digital images. For example, the digital design system 106 provides access to multi-part object classifier 114. In some embodiments, the editable classification system 102 accesses multi-part object classifier 114 to determine similarity scores between known classes and a multi-part object within a digital image. In some implementations, the digital design system 106 provides textual descriptors linked to one or more bounding boxes indicating object parts to particular digital profiles associated with client devices (e.g., the client device 110).

In one or more embodiments, the server device(s) 104 includes all, or a portion of, the editable classification system 102. For example, the editable classification system 102 operates on the server device(s) 104 to determine a classification of a multi-part object via a multi-part object classifier 114. In some embodiments, the client device 110 includes all or part of the editable classification system 102. For example, the client device 110 generates, obtains (e.g., downloads), or uses one or more aspects of the editable classification system 102 and/or the multi-part object classifier 114. Indeed, in some implementations, as illustrated in FIG. 1, the editable classification system 102 is located in whole or in part of the client device 110 (e.g., as part of the client application 112). For example, the editable classification system 102 includes a web hosting application that allows the client device 110 to interact with the server device(s) 104. To illustrate, in one or more implementations, the client device 110 accesses a web page supported and/or hosted by the server device(s) 104.

Although FIG. 1 illustrates a particular arrangement of the system environment 100, in some embodiments, the system environment 100 has a different arrangement of components and/or may have a different number or set of components altogether. For instance, as mentioned, the editable classification system 102 is implemented by (e.g., located entirely or in part on) the client device 110. In addition, in one or more embodiments, the client device 110 communicates directly with the editable classification system 102, bypassing the network 108.

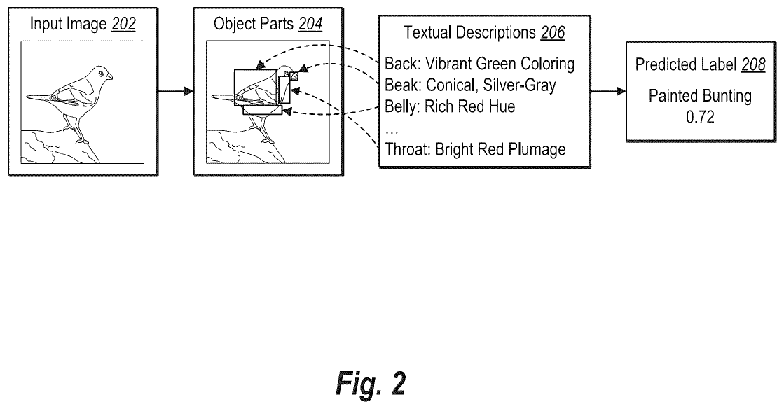

As mentioned above, in certain embodiments, the editable classification system 102 performs operations for generating a classification (e.g., predicted label) for a multi-part object within a digital image. In particular, in various cases, the editable classification system 102 generates a set of bounding boxes corresponding to object parts and links the object parts to textual descriptors. FIG. 2 illustrates an overview diagram of the editable classification system 102 generating a predicted label for an input image in accordance with one or more embodiments. Additional detail regarding the various acts and processes introduced in relation to FIG. 2 is provided thereafter with reference to subsequent figures.

As illustrated in FIG. 2, in some cases, the editable classification system 102 detects (or receives) an input image 202 (e.g., a digital image) comprising a multi-part object belonging to a particular domain. For example, the input image 202 comprises a Painted Bunting (a multi-part object) belonging to a particular domain (birds). In one or more embodiments, the editable classification system 102 detects an input image 202 with a multi-part object belonging to one of a variety of known domains (e.g., birds, dogs, cars, etc.). In some cases, a multi-part object refers to or includes a set of pixels of a digital image that represent an object comprising a plurality of parts (e.g., object parts) relevant to a domain of the object that, in combination, indicate a class of the object.

As further illustrated in FIG. 2, in various embodiments, the editable classification system 102 generates, for display within the input image 202, a plurality of bounding boxes 204 corresponding to the object parts of the multi-part object. In some cases, the editable classification system 102 receives (or determines) a list of object parts corresponding to the domain of the multi-part object. For example, for the domain “birds,” the editable classification system 102 determines a textual list of bird parts including: “back”, “beak”, “belly”, “throat”, etc. In one or more embodiments, the editable classification system 102 generates a set of bounding boxes that encapsulate regions of the input image 202 corresponding to the object parts of the multi-part object.

As shown in FIG. 2, in one or more cases, the editable classification system 102 determines textual descriptors 206 corresponding to a plurality of classes within the detected domain. In various embodiments, the editable classification system 102 determines a set of textual descriptors 206 that, using natural language text, describe the object parts of a plurality of classes. In some cases, the editable classification system 102, for a known class, determines a subset of textual descriptors 206 that includes list of object parts for the domain and corresponding textual descriptors 206 specific to that class. For example, for a “painted bunting” class, the editable classification system 102 determines a subset of textual descriptors 206 that include “back: vibrant green coloring” and “beak: conical, silver-gray.” In some cases, textual descriptors refer to or include natural language text descriptions of object parts that correspond to a particular class within a domain.

In various embodiments, the editable classification system 102 links a subset of textual descriptors 206 corresponding to a known class to the bounding boxes 204 within the input image 202. The editable classification system 102, in some cases, links the object parts of the bounding boxes 204 to the textual descriptors 206 visually (e.g., by utilizing color coordination). For example, the editable classification system 102 provides a red bounding box around the “beak” of the multi-part object and correspondingly lists the “beak” textual descriptor in red text or with a red background. In one or more embodiments, the editable classification system 102 additionally (or alternatively) visually links the textual descriptors 206 and the bounding boxes 204 representing object parts with other visual methods. The editable classification system 102, in some cases, visually links the object parts and the textual descriptors 206 by arrows from the relevant object part of the textual description to the object parts within the input image, as shown by bounding boxes 204.

As further shown in FIG. 2, the editable classification system 102, in one or more embodiments, generates a predicted label 208, indicating a classification for the multi-part object within the input image 202 by utilizing a multi-part object classifier. In various cases, the editable classification system 102 generates a predicted label 208 based on relationships (e.g., part-level matching) between the visual object parts of the multi-part object and the textual descriptors 206. In some embodiments, the editable classification system 102, via the multi-part object classifier, determines a similarity score for a known class, indicating a likelihood that the multi-part object of the input image 202 belongs to a known class associated with a subset of textual descriptors 206. In some cases, a predicted label 208 refers to or includes a classification of the multi-part object based on part-level matching that indicates relationships between subsets of textual descriptors 206 and object parts of a multi-part object.

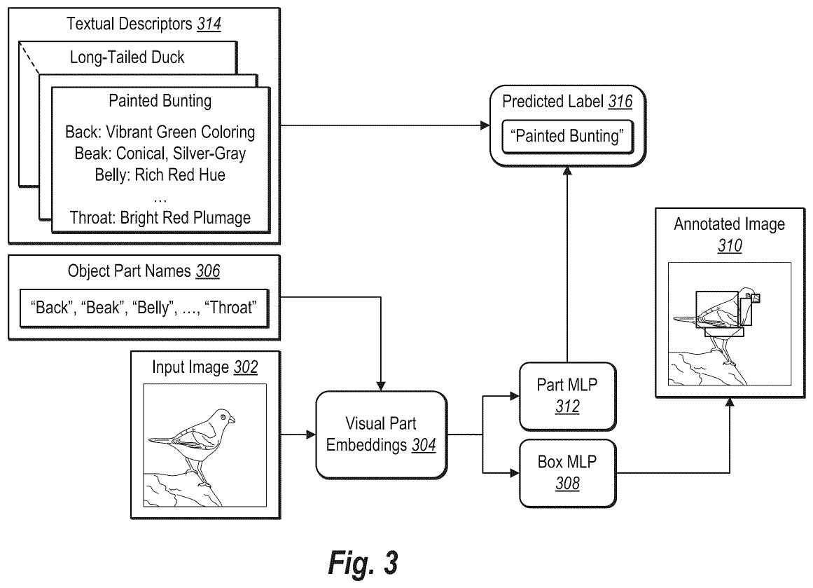

As mentioned above, in certain described embodiments, the editable classification system 102 generates a predicted label for a multi-part object within a digital image. In particular, in some cases, the editable classification system 102 generates a predicted label by utilizing part-level matching to compare textual descriptors to visual part embeddings. FIG. 3 illustrates a diagram of the editable classification system 102 generating a predicted label for an input image by selecting visual part embeddings in accordance with one or more embodiments.

As illustrated in FIG. 3, the editable classification system 102 receives or otherwise determines object part names 306 relevant to the domain of the multi-part object detected in input image 302. In one or more embodiments, the editable classification system 102 defines the parts of interest in identifying a class within the domain of the multi-part object within the digital image (e.g., input image 302). For example, in one or more embodiments, given 12 parts of interest in defining birds, the editable classification system 102 generates (or receives) 12 object parts that are utilized in defining a class (e.g., species) of birds. In the instance of birds, the editable classification system 102 generates object part names 306 including: crown, forehead, nape, eyes, beak, throat, breast, belly, back, wings, legs, and tail. In these or other embodiments, the editable classification system 102 generates more or fewer than 12 relevant object parts depending on the number of object parts used to differentiate one class of the domain from another class of the domain.

In some cases, the editable classification system 102 generates a text string of the object part names 306 by providing a query to a large language model (“LLM”) with the relevant domain of the multi-part object of the input image 302. In various embodiments, the editable classification system 102 provides an LLM with instructions to generate a text string (e.g., a comma delimited text string) including the parts used to define a class within the relevant domain and the name of the relevant domain. In these or other embodiments, the editable classification system alternatively retrieves a predefined list of object part names 306 from a database. In various embodiments, the editable classification system 102 provides for further manipulation (e.g., user manipulation) of the text string including the object part names 306 after retrieval from a database and/or generation by an LLM.

As further illustrated in FIG. 3, the editable classification system 102 facilitates the selection of visual part embeddings 304 by generating relationships between an input image 302 and object part names 306. In particular, in some embodiments, the editable classification system 102 selects visual part embeddings 304 that map the object part names 306 to pixels within the input image 302 that represent the respective object parts. In various cases, the visual part embeddings 304 are predicted contextualized embeddings for each object part corresponding to the object part names 306. For example, the editable classification system 102 generates visual part embeddings 304 that map the object part name “beak” to pixels within the input image 302 that visually depict the “beak” of the multi-part object within the digital image (e.g., input image 302).

As shown in FIG. 3, the editable classification system 102, by utilizing a Box MLP 308 (e.g., a box neural network layer), visually displays the mappings of the visual part embeddings 304 by overlaying bounding boxes on the input image 302 to generate an annotated image 310. In some cases, the Box MLP 308 is a three-layer Multilayer Perceptron (“MLP”) with a Gaussian Error Linear Unit (“GELU”) activation after each of the first two layers. In various embodiments, the editable classification system 102, via the Box MLP 308, predicts a set of bounding boxes according to the visual part embeddings. In various cases, the editable classification system 102, via the Box MLP 308, generates a set of bounding boxes where each bounding box of the set of bounding boxes is color coordinated with (or otherwise linked to) an object part name of the set of object part names 306.

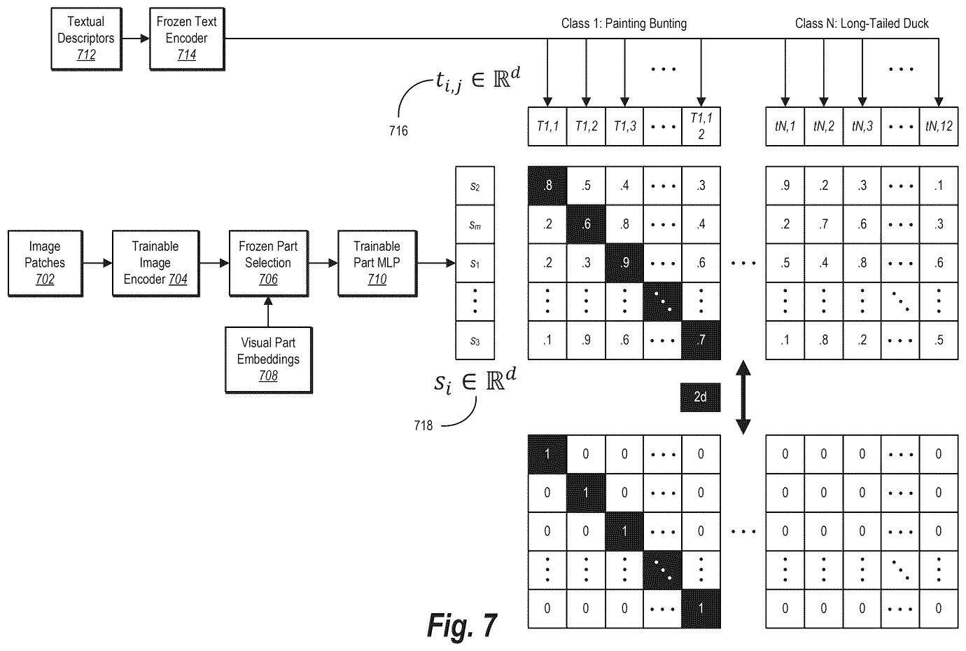

As also illustrated in FIG. 3, the editable classification system 102, in one or more embodiments, utilizes a Part MLP 312 (e.g., a part neural network layer) to generate a predicted label 316. In some cases, the Part MLP 312 comprises a three-layer MLP with GELU activations. Specifically, in various cases, the Part MLP 312 receives (or detects) the visual part embeddings (e.g., selected part embeddings) and outputs a vector of size ^{d}, where d is the dimension of the descriptor embeddings. In some embodiments, the editable classification system 102 trains the Part MLP 312 to map the selected part embeddings to the same dimensional space as descriptor embeddings (based on textual descriptors 314) to determine final logits for classification of the multi-part object (e.g., predicted label 316). The training of Part MLP 312 is discussed further below in relation to FIG. 7.

As shown in FIG. 3, the editable classification system 102 utilizes textual descriptors 314 (in combination with the output of Part MLP 312) to generate a predicted label 316. To generate the predicted label 316, the editable classification system 102, in one or more cases, utilizes a multi-part object classifier that matches textual descriptors 314 to the visual part embeddings 304. Specifically, in some cases, the editable classification system 102, via the multi-part object classifier, facilitates parts-level matching by generating similarity scores between subsets of textual descriptors 314 and visual part embeddings 304. In various embodiments, by linking visual part embeddings and textual descriptors, the editable classification system provides rationale (e.g., reasoning) behind the matching of image details of input image 302 to textual descriptors 314.

In one or more embodiments, the editable classification system 102 determines or receives subsets of textual descriptors 314 corresponding to known classes, where the subset of textual descriptors comprises textual descriptors for the object parts of the known class. For example, the editable classification system 102, for a bird domain, constructs a subset of textual descriptors 314 for known species of birds (e.g., classes of birds), where the subset of textual descriptors 314 describes the parts of the species. In various cases, the editable classification system 102 generates textual descriptors 314 that are natural language descriptors and thus human understandable. In some cases, the editable classification system 102 utilizes an LLM (such as GPT-4) to generate the part-based descriptors (e.g., textual descriptors 314). To generate the textual descriptors 314, the editable classification system 102, in one or more cases, provides a plurality of digital images with multi-part objects to an LLM with instructions to describe the object parts of the multi-part object.

In various embodiments, the editable classification system 102 generates a predicted label 316 by generating relationships between textual descriptors 314 and visual part embeddings 304. For example, in some cases, the editable classification system 102, via a multi-part object classifier, generates a similarity score between a set of textual descriptors 314 related to a known class and the visual part embeddings 304. To determine a predicted label 316 for the input image 302, the editable classification system 102, in some cases, compares similarity scores for two or more classes. For instance, the editable classification system 102 determines a first similarity score for a first class by comparing a first subset of textual descriptors 314 of the first class to the visual part embeddings 304 and a second similarity score of a second class by comparing a second subset of textual descriptors 314 of the second class to the visual part embeddings 304 to determine the predicted label 316. In various cases, the editable classification system 102 determines the predicted label 316 by comparing multiple similarity scores and selecting the class linked to the highest score (greatest score) as the predicted label 316.

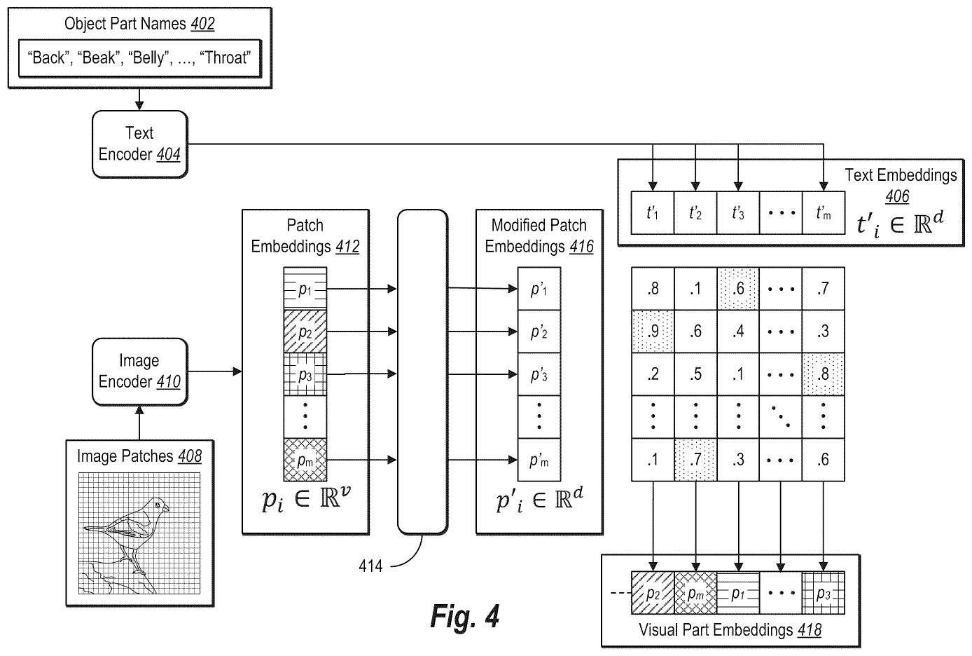

As noted above, in certain described embodiments, the editable classification system 102 generates visual part embeddings representing relationships between an input image and object part names. In particular, the editable classification system 102 generates visual part embeddings by utilizing a text encoder and a text decoder. FIG. 4 illustrates a diagram of the editable classification system generating visual part embeddings that map relationships between object part names and image patches in accordance with one or more embodiments.

As illustrated in FIG. 4, the editable classification system 102, in some cases, utilizes a text encoder 404 to generate text embeddings 406 from object part names 402. For example, the editable classification system 102, via the text encoder 404, generates a vector for the object part names 402 as input by a text string comprising the object part names 402 corresponding to the relevant domain (e.g., domain of multi-part object of the input image). Similarly, the editable classification system 102, in one or more embodiments, utilizes an image encoder 410 to generate patch embeddings 412 from image patches 408.

As also illustrated in FIG. 4, in various cases, the editable classification system 102 utilizes linear projection 414 to generate modified patch embeddings 416 in the same dimension as text embeddings 406. In one or more embodiments, the linear projection 414 (e.g., a linear projection layer) comprises a learnable logit scale, a learnable logit shift, and/or an exponential linear unit (“ELU”) activation function. In some cases, the editable classification system 102, by utilizing the linear projection 414, transforms the processed image embeddings (e.g., patch embeddings 412) to be in the same dimension as the text embeddings 406. In one or more embodiments, the editable classification system 102 utilizes text/image encoders that encode the object part names 402 and the image patches 408 into the same feature space.

As shown in FIG. 4, in some embodiments, the editable classification system 102 generates visual part embeddings 418 by determining relationships between text embeddings 406 and modified patch embeddings 416. In one or more cases, the editable classification system 102 selects a single image embedding (e.g., patch embedding) for each text query of the object part names 402. For example, in the context of a bird domain, the text queries (object part names 402) correspond to the component names of the target object (e.g., multi-part object), which includes twelve distinct parts. In one or more embodiments, the editable classification system 102 generates visual part embeddings 418 by determining a cosine similarity between the projected image embeddings (e.g., modified patch embeddings 416) and the text embeddings 406 to generate a contextualized embedding. For example, the editable classification system 102 selects the visual part embeddings 418 based on the highest cosine similarity between the modified patch embeddings 416 and the text embeddings 406 representing the encoded part names.

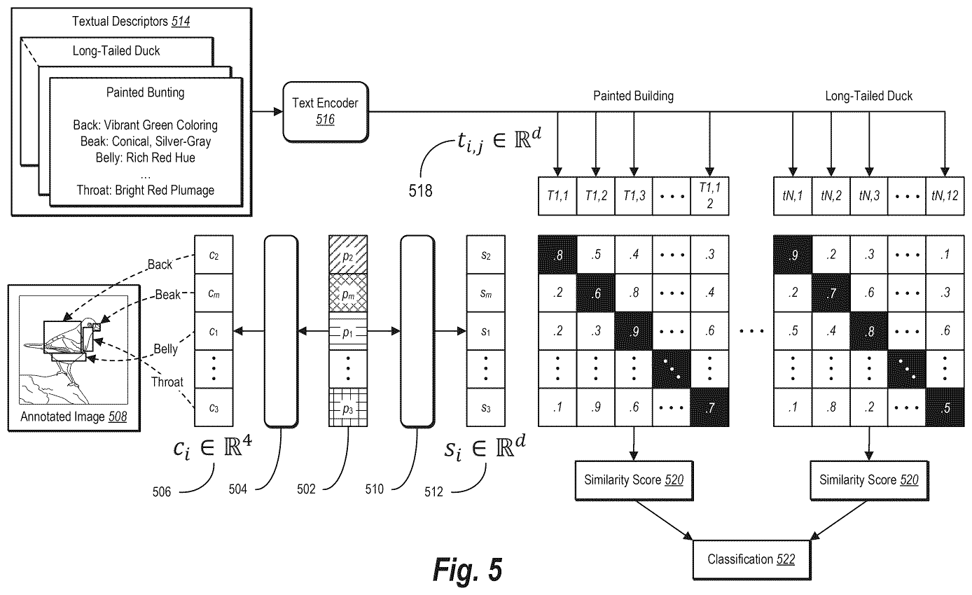

As noted above, in certain described embodiments, the editable classification system 102 generates a predicted classification for a multi-part object within a digital image. Specifically, in some cases, the editable classification system 102 utilizes various neural network layers to compare the multi-part object to known classifications. FIG. 5 illustrates a diagram of the editable classification system 102 generating an annotated image and a classification of a multi-part object accordance with one or more embodiments.

As illustrated in FIG. 5, in some embodiments, the editable classification system 102 utilizes a Box MLP 504 (e.g., a box neural network layer) to generate an annotated image 508 from the visual part embeddings 502. In some embodiments, the editable classification system 102 utilizes a Box MLP 504 that comprises a three-layer MLP with a GELU activation after the first two layers. In these or other cases, the editable classification system 102 comprises a bounding-box regression head.

In particular, in various cases, the editable classification system 102 utilizes a Box MLP 504 to visualize the visual part embeddings 502 within a digital image. In one or more embodiments, the editable classification system 102 generates localized parts 506 in a center format, where the Box MLP 504 generates a four-element vector corresponding to the center coordinates and size of a bounding box. In various cases, the editable classification system 102 determines a vector, for each object part, comprising the x-coordinate and the y-coordinate of the center point of the bounding box. In these or other embodiments, the editable classification system 102, via the Box MLP, additionally (or alternatively) generates a vector for each object part comprising the width and height of each bounding box.

As illustrated in FIG. 5, the editable classification system 102 generates an annotated image 508 based on the localized parts 506. In particular, the editable classification system 102 generates a plurality of bounding boxes (or a set of bounding boxes) as defined by the vectors of localized parts 506. For example, each bounding box encompasses a set of pixels of the digital image that pertain to an object part of the multi-part object. In some cases, the annotated image 508 comprises a set of bounding boxes where each bounding box of the set of bounding boxes is identified by a color coordination system. In these or other cases, the bounding boxes are linked to an object part by a visual connector (e.g., a line, an arrow, etc.) that connects the bounding box within the annotated image 508 to text describing the object part (e.g., back, beak, throat). In various embodiments, the editable classification system 102 generates bounding boxes within the annotated image 508 according to the center coordinates and bounding box size as indicated in the localized parts 506.

As shown in FIG. 5, in various cases, the editable classification system 102 utilizes the visual part embeddings 502 to generate a predicted classification 522 (e.g., a predicted label). In some embodiments, the editable classification system 102 utilizes a Part MLP 510 to generate modified visual part embeddings 512 from the visual part embeddings 502. In one or more cases, the Part MLP 510 generates the modified visual part embeddings 512 in the dimension of the descriptor embeddings 518. In particular, in some embodiments, the editable classification system 102 generates the modified visual part embeddings 512 in the dimension of the descriptor embeddings 518 to facilitate the comparison of (e.g., generating relationships between) the modified visual part embeddings 512 and the descriptor embeddings 518.

In some cases, as shown in FIG. 5, the editable classification system 102 generates descriptor embeddings 18 from the textual descriptors 514 via the text encoder 516. In one or more embodiments, the editable classification system 102, via the multi-part object classifier, generates parts-based matching (e.g., relationships) between the descriptor embeddings 518 and the modified visual part embeddings 512. In particular, in some cases, the editable classification system 102 reveals which image details of the input image are utilized in classification by matching textual descriptors 514 to corresponding visual object parts via the visual part embeddings 502.

In some embodiments, the editable classification system 102 performs descriptor embedding matching (e.g., parts-based matching) via a dot product to quantify the similarity between the embedding output from the Part MLP (modified visual part embeddings 512) and corresponding part-descriptor embeddings (e.g., textual descriptors 514). In particular, in some cases, the editable classification system 102 generates a set of unnormalized distances between the input image and possible classifications by determining a dot product between the set of visual part embeddings 502 and subsets of textual descriptors 514.

In these or other cases, the editable classification system 102 generates a similarity score 520 (e.g., an overall similarity score) for each subset of textual descriptors 514 related to a known class. For example, the editable classification system 102, generates a first similarity score for the subset of textual descriptors 514 related to the known class “painted bunting” and a second similarity score for the subset of textual descriptors 514 related to the known class “long tailed duck.”

In various cases, the editable classification system 102 utilizes a similarity matrix of the modified visual part embeddings 512 (e.g., projected visual part embeddings) and the descriptor embeddings 518 to determine a similarity score 520. For instance, the editable classification system 102 generates a sum (or average or norm) of the corresponding similarities of each object part in the descriptor embeddings 518 pertaining to a subset of textual descriptors 514 related to a class. In one or more embodiments, the editable classification system 102 generates a similarity score 520 for each of the subset of textual descriptors 514 (e.g., each class) to generate a predicted classification 522.

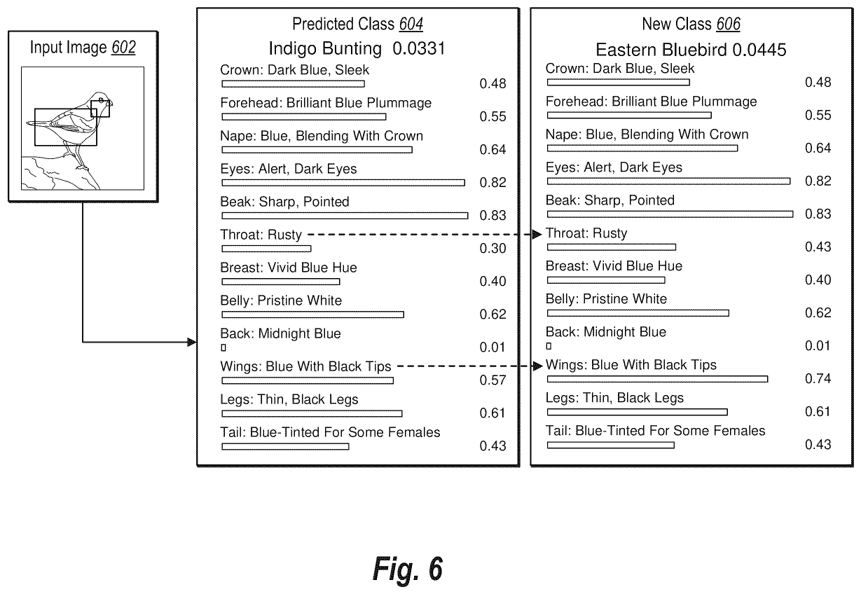

As mentioned above, in certain described embodiments, the editable classification system 102 generates a new class for a multi-part object within a digital image. In addition, the editable classification system 102, in some cases, facilitates the modification of textual descriptors to add a new class to a database of known classes. FIG. 6 illustrates a diagram of the editable classification system generating a new class by editing textual descriptors in accordance with one or more embodiments.

As illustrated in FIG. 6, the editable classification system 102, as discussed previously, generates a predicted classification (e.g., predicted class 604) according to relationships between sets of textual descriptors and visual part embeddings of an input image 602. In various cases, the editable classification system 102 provides a graphical user interface with the predicted class 604 and associated textual descriptors. In one or more embodiments, the editable classification system 102 displays the predicted class 604 with the associated similarity score and/or the similarity scores for the subset of textual descriptors of that predicted class 604 (e.g., known class). In one or more cases, the input image 602 is displayed in the graphical user interface with bounding boxes corresponding to the object parts of the multi-part object. In various embodiments, the editable classification system 102 displays the input image 602 with bounding boxes, in conjunction with the relevant textual descriptors, to provide a visual display of the rationale of the editable classification system 102 in generating the predicted class 604.

As further illustrated in FIG. 6, in some embodiments, the editable classification system 102 allows for the editing of textual descriptors of the predicted class 604 to generate a new class 606. In particular, in various cases, the editable classification system 102, by editing the text of textual descriptors that do not match with the multi-part object of the input image 602, generates a new class 606. For example, if an input image comprises a pictural representation of a bird that is of a class unknown to the system, the editable classification system 102 generates a predicted class 604 that is the closest class known to the system. However, as the predicted class 604 will not be the correct class, one or more of the textual descriptors, in these embodiments, will incorrectly describe the object parts of the multi-part object.

To correct the inaccurate textual descriptors, in various cases, the editable classification system 102 modifies the text of the relevant subset of textual descriptors to match the input image 602 by generating a modified subset of textual descriptors. Upon generating the modified subset of textual descriptors, in some embodiments, the editable classification system 102 saves the modified subset of textual descriptors as a new subset of textual descriptors associated with a new class. Similarly, the editable classification system 102, in some cases, saves a new text string as the name of the new class 606. For example, for an input image 602 that contains an Eastern Bluebird, the editable classification system 102 generates a predicted class 604 of “Indigo Bunting” where the “throat” and “wings” textual descriptors do not match the image. Upon modifying the “throat” and “wings” textual descriptors, the editable classification system 102 updates the new class 606 as “Eastern Bluebird.” In these or other embodiments, the new class name is determined by textual input by a user through a graphical user interface.

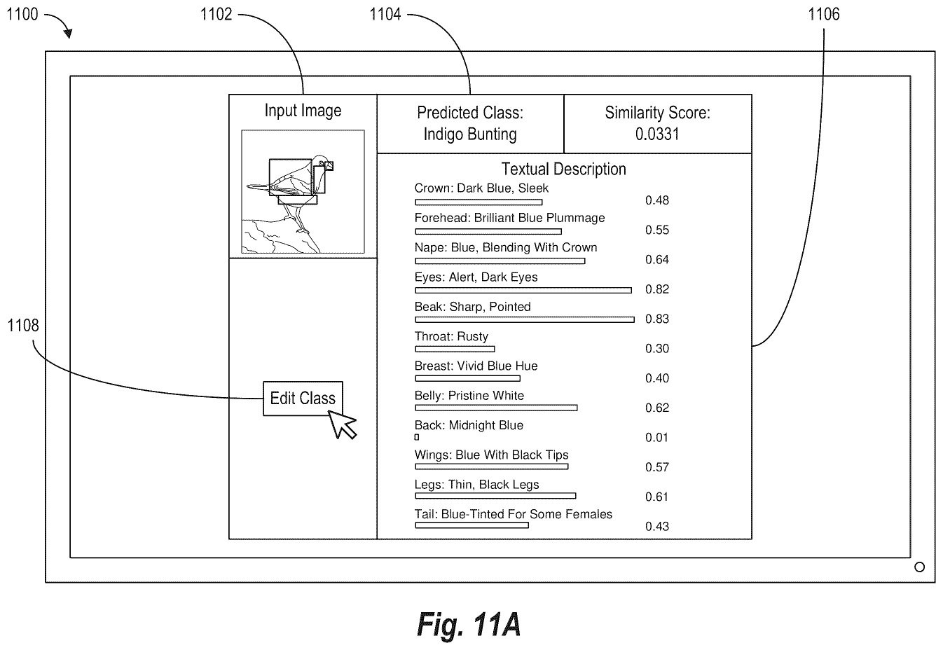

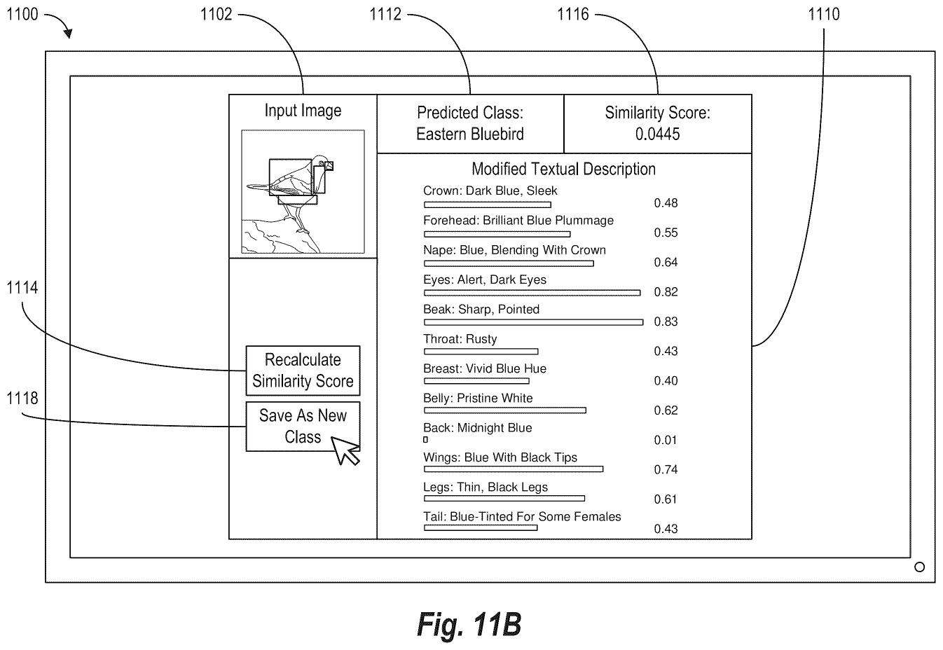

In various embodiments, the editable classification system 102 adds a new class 606 to a known database of classes, where the new class 606 is then retrievable as a known class in subsequent inquiries. In these or other cases, the editable classification system 102 alternatively adds a new class by adding the new classifier (e.g., class) to a classifier neural network (e.g., multi-part object classifier) where the new classifier is, upon addition, retrievable as a known class to identify future multi-part objects without additional training of the classifier neural network. A graphical user interface for adding a new class is further discussed in relation to FIGS. 11A-11B.

In one or more embodiments, the editable classification system 102 modifies (or edits) the input image 602 to generate an predicted class 604 and/or annotated image. In particular, in various cases, the editable classification system 102 faciliates the editing of the input image 602 to modify one or more aspects of the bird depicted in the input image 302. As a result of the modified input image, the editable classification system 102, in some embodiments, generates updated textual descriptors based on the modified input image, such as by finding the best matching descriptions for the modified aspect(s) and generates a best matching classification. Furthermore, in one or more cases, the editable classification system 102 generates, from the modified input image and/or the updated textual descriptors, a predicted class 604 different than the original (unmodified) input image 602.

As mentioned above, in some cases, the editable classification system 102 utilizes a Part MLP to generate a predicted classification. In particular, in various embodiments, the editable classification system 102 utilizes a trained image encoder in conjunction with a trained Part MLP to generate a predicted classification. FIG. 7 illustrates a diagram of training the editable classification system 102 by contrastive training between object parts and textual descriptors in accordance with one or more embodiments.

As shown in FIG. 7, in some embodiments, the editable classification system 102 trains the image encoder (e.g., trainable image encoder 704) and the part MLP (e.g., trainable part MLP 710) contrastively to let the image encoder learn the general representation of different object parts of multi-part objects. In some cases, the editable classification system 102 follows a teacher model (e.g., a vision-transformer neural network) to select visual part embeddings 708 to ensure the selected part embeddings are semantically meaningful (e.g., can be used for bounding box prediction). In various embodiments, the editable classification system 102 utilizes the teacher model to encode the object part names and the input image to generate visual part embeddings 708. Specifically, in one or more cases, the editable classification system 102, derives text embeddings from the object part names and patch embeddings from the input image to generate visual part embeddings 708. Further, in some cases, the editable classification system 102 generates the visual part embeddings 708 by determining a dot product between projected patch embeddings (via linear projection) and text embeddings (via a text encoder).

In one or more embodiments, the editable classification system 102 pre-trains the trainable image encoder 704 and the trainable part MLP 710 on a dataset comprising a plurality of classes within a relevant domain. For example, as editable classification system 102 matches visual parts to textual descriptors, the dataset requires images with multi-part objects that are distinctly visible and sufficiently large for accurate part localization and matching. In various cases, the editable classification system 102 harnesses a multi-part object detector to detect a multi-part object in all dataset images and filter out images where the detected bounding box is smaller than a predetermined size threshold (e.g., 100×100 pixels), thus generating a dataset with sufficiently visible multi-part objects.

In determining a training dataset, the editable classification system 102, in some cases, utilizes classes with fine-trained class labels (e.g., Yellow vs. Northern Cardinal) as opposed to general class labels (e.g., Cardinal) for more diverse training and to avoid label ambiguity. In various embodiments, the editable classification system 102 generates a set of part-based descriptors for a test image comprising a multi-part object of a known class utilizing a large language model. To generate the part-based descriptors for a test image, in one or more cases, the editable classification system 102 provides the test image along with the previously generated part-based descriptors for known classes in an LLM prompt and ask the LLM to choose a matching class label for the test image.

In various embodiments, the editable classification system 102 jointly trains the trainable image encoder 704 and the trainable part MLP 710 layer jointly using a symmetric cross entropy (CE) loss to learn the mapping between visual part embeddings 708 and textual descriptors 712. In various cases, the editable classification system 102 maximizes similarity between related part-descriptor pairs while minimizing unrelated part-descriptor pairs using symmetric CE loss. In particular, in various cases, the editable classification system 102 trains the trainable image encoder 704 contrastively to maximize the similarity between part-descriptor pairs (e.g., between visual part embeddings 708 and textual descriptors 712). Additionally, in one or more embodiments the editable classification system 102 trains the trainable image encoder 704 and the trainable part MLP 710 simultaneously to maximize similarity between part-descriptor pairs.

In various cases, the editable classification system 102 trains the trainable image encoder 704 and the trainable part MLP while freezing (e.g., not updating parameters of) the text encoder (e.g., frozen text encoder 714) and the part selection (e.g., frozen part selection 706). In some cases, the editable classification system 102 trains the trainable image encoder 704 and the trainable part MLP 710 separate from the linear projection and box MLP layers to reduce the time necessary to optimize two symmetric cross-entropy losses while maintaining high-quality predicted bounding boxes.

As shown in FIG. 7, in various cases, the editable classification system 102 encodes the textual descriptors 712 with the frozen text encoder 714 and the image patches 702 with the trainable image encoder 704 to obtain descriptor embeddings 716 and patch embeddings. Specifically, the editable classification system 102, in some embodiments, selects the patch embeddings via frozen part selection 706 and based on the visual part embeddings 708 (e.g., relationships generated by the teacher model). From the patch embeddings, the editable classification system 102, in various embodiments, projects the patch embeddings into a dimension of the descriptor embeddings 716 via the trainable part MLP 710.

As further illustrated in FIG. 7, in one or more cases, the editable classification system 102 generates a similarity matrix for the projected patch embeddings 718 and the descriptor embeddings 716 by computing the dot product between the projected patch embeddings 718 and the descriptor embeddings 716. In various embodiments, the editable classification system 102 generates a one-hot encoded matrix based on the textual descriptors 712 as the ground truth label. In these or other embodiments, the editable classification system 102 utilizes the one-hot encoded matrix to minimize the symmetric cross-entropy loss between the similarity matrix and the ground truth label.

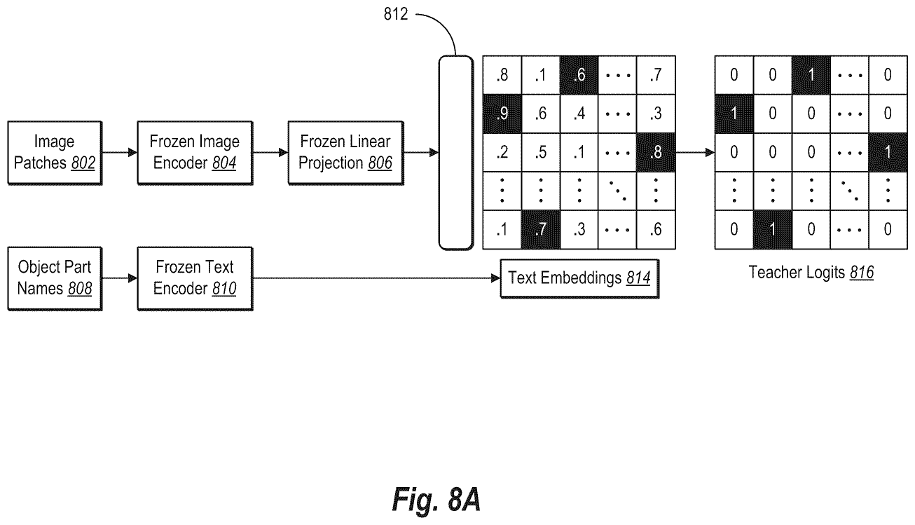

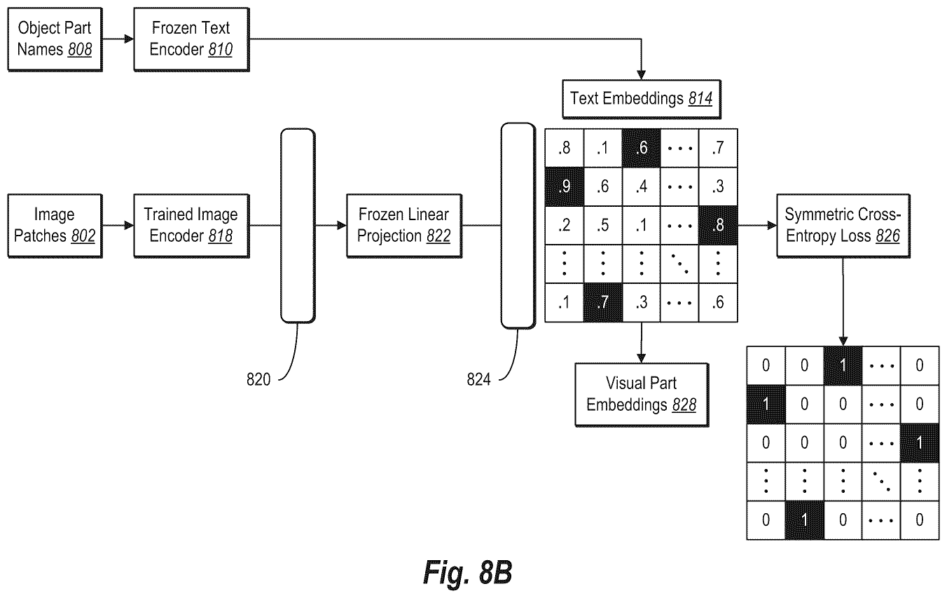

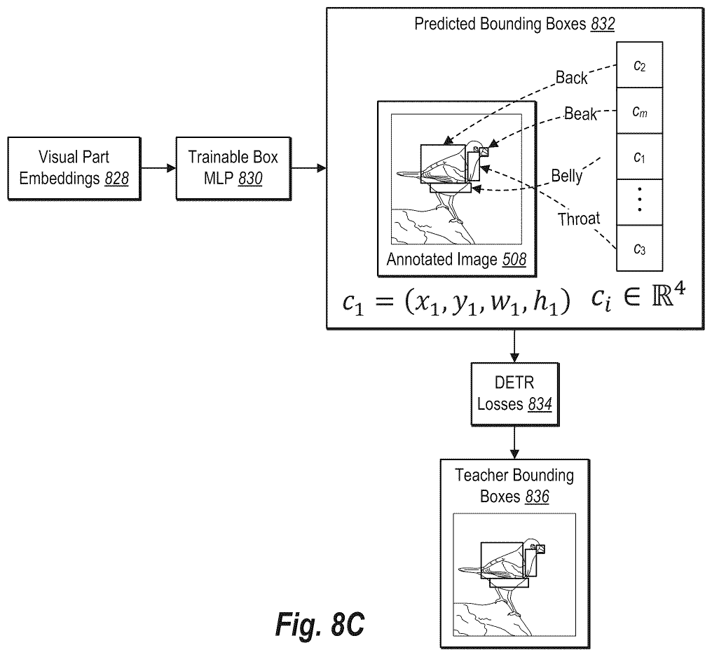

As noted above, in certain embodiments, the editable classification system 102 trains various architectural components to generate a classification of a multi-part object. In particular, the editable classification system 102 trains a linear projection layer and a box MLP to generate a classification of a multi-part object within a digital image. FIGS. 8A-8C illustrate diagrams of the editable classification system jointly training a linear projection layer and a box neural network layer in accordance with one or more embodiments.

As illustrated in FIG. 8A, the editable classification system 102 trains the linear projection layer and the box MLP to eliminate the teacher model and obtain a standalone classifier. In particular, the editable classification system 102, in some cases, encodes the object part names 808 with the frozen text encoder 810 to obtain text embeddings and encodes the image patches 802 with the frozen image encoder 804 in combination with the frozen linear projection 806 to obtain patch embeddings 812.

In some embodiments, as shown in FIG. 8A, the editable classification system 102 generates a dot product between the patch embeddings 812 and the text embeddings 814, where the patch embeddings 812 and the text embeddings 814 are in the same dimension. As further shown in FIG. 8A, the editable classification system 102, in one or more cases, one-hot encodes the dot product (e.g., matrix) to generate teacher logits 816.

FIG. 8B illustrates a diagram of training the editable classification system 102 by training the linear projection in accordance with one or more embodiments. In various cases, the editable classification system 102 encodes the image with a trained image encoder 818 (as previously discussed in relation to FIG. 8A) to generate patch embeddings 820. In some embodiments, the editable classification system 102 utilizes trainable linear projection 822 to project patch embeddings 820 into projected patch embeddings 824 to be in the same dimension as text embeddings 814. Additionally, in various embodiments, the editable classification system 102 generates text embeddings 814 from object part names 808 by utilizing a frozen text encoder 810. In one or more cases, the editable classification system 102 generates a similarity matrix by determining the dot product of the projected patch embeddings 824 and the text embeddings 814. In some embodiments, the editable classification system 102 generates visual part embeddings 828 from the similarity matrix. In various embodiments, the editable classification system 102 utilizes symmetric cross-entropy loss 826 between the similarity matrix and the teacher logits 816 as described in relation to FIG. 8A.

FIG. 8C illustrates a diagram of training the editable classification system 102 by training the box neural network layer (e.g., box MLP 830) in accordance with one or more embodiments. In various cases, the editable classification system 102 generates predicted bounding boxes 832 from the visual part embeddings 828 as generated by the trainable linear projection layer (discussed in relation to FIG. 8B). In some embodiments, the editable classification system 102 generates predicted bounding boxes 832 from visual part embeddings 828 by utilizing a trainable Box MLP 830. In one or more cases, the editable classification system 102 generates predictions for the coordinates of object part embeddings within an input image. In various cases, the editable classification system 102 computes detection transformer (DETR) losses 834 for the predicted bounding boxes 832 (e.g., predicted coordinates). In these or other embodiments, the editable classification system 102 compute DETR losses 834 by comparing the predicted bounding boxes 832 to teacher bounding boxes 836 to determine set-based global losses that forces unique predictions via bipartite matching in a transformer-based architecture.

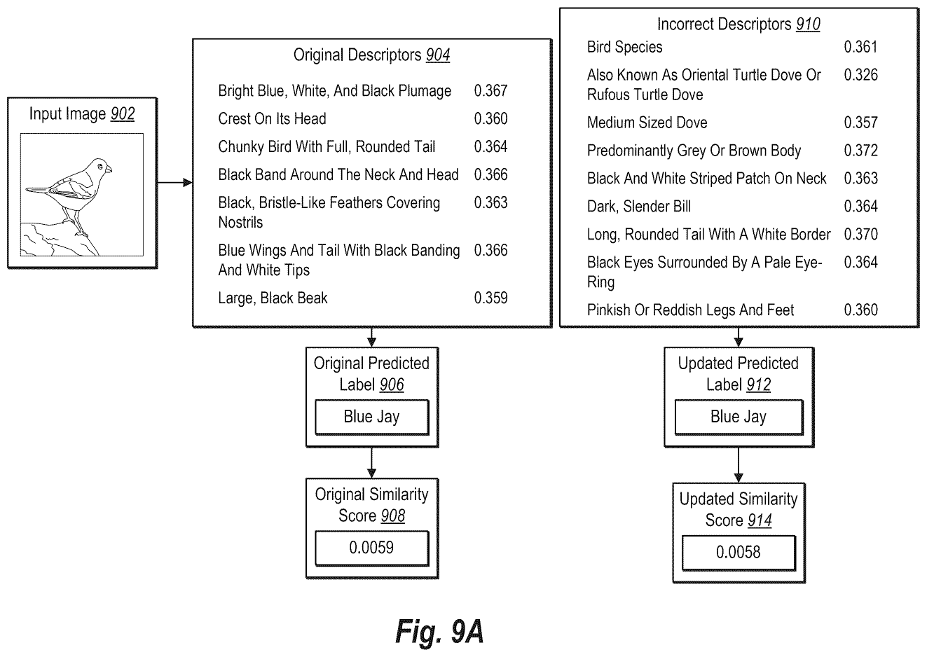

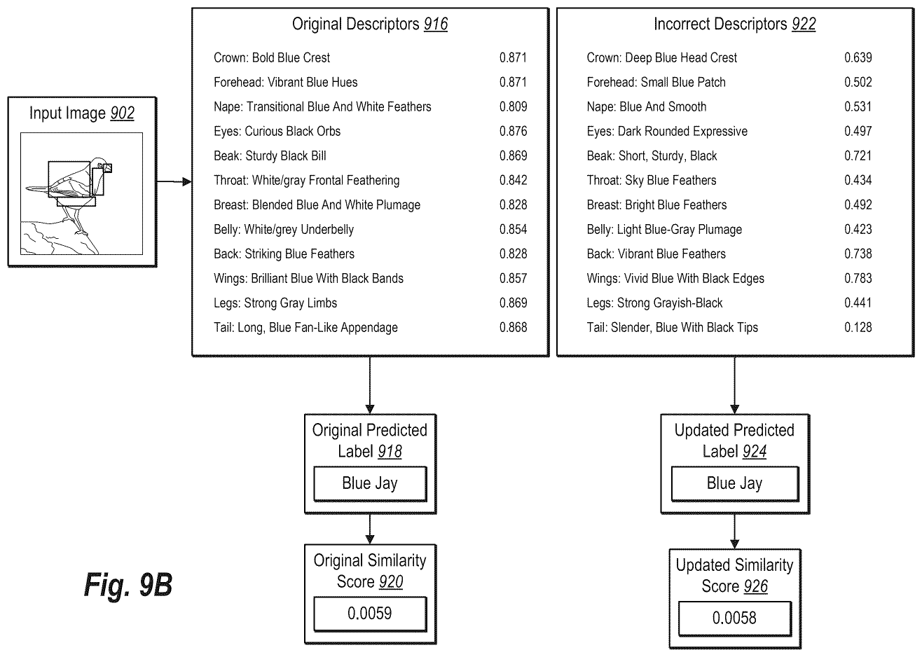

As noted above, in certain embodiments, the editable classification system 102 generates a classification for a multi-part object by matching textual descriptors to a digital image. In particular, the editable classification system 102 relies on the textual descriptors instead of a class identifier to generate the classification. FIGS. 9A-9B illustrate diagrams of the editable classification system and a conventional system generating a classification for a multi-part object in accordance with one or more embodiments.

As illustrated in FIG. 9A, in some cases, a conventional classification system (as opposed to the editable classification system 102) is provided with an input image 902 of a multi-part object. Given the original descriptors 904 that correspond to the multi-part object of the input image 902, in conjunction with a class name corresponding to the input image 902, the conventional classification system generates an original predicted label 906. For example, when provided with an input image 902 comprising a Blue Jay bird, with the class name “Blue Jay,” the conventional classification system generates an original predicted label 906 of “Blue Jay.” Additionally, the conventional classification system generates an original similarity score 908 of “0.0059.”

In various embodiments, when the conventional classification system is given random descriptors (e.g., incorrect descriptors 910) that do not match the input image 902 but is still provided with the class name “Blue Jay,” the conventional classification system generates an updated predicted label 912 of “Blue Jay.” By generating the correct predicted label with incorrect descriptors 910 that do not match the input image, the conventional classification system illustrates heavy reliance of the system on class names. Similarly, the conventional classification system provided a substantially similar updated similarity score 914 of “0.0058.”

In contrast, as illustrated in FIG. 9B, the editable classification system 102, in some cases, generates an original predicted label 918 based on original descriptors 916 related to an input image 902. In particular, in some cases, the editable classification system 102 is provided with original descriptors 916 that match the input image 902 depicting a Blue Jay bird and generates the original predicted label 918 comprising “Blue Jay.” In these or other cases, the editable classification system 102 does not utilize a class name to generate the original predicted label 918. In other embodiments, the editable classification system 102 utilizes a class name, but does not exclusively rely on the class name (e.g., relies on the original descriptors 916) to generate the original predicted label 918. In various embodiments, the editable classification system 102 additionally (or alternatively) generates an original similarity score 920 of “0.6899,” representing the similarity between the object parts of the multi-part object and the original descriptors 916.

As also illustrated in FIG. 9B, the editable classification system 102, in various cases, generates an updated predicted label 924 that does not match the input image 902 when provided with randomized descriptors (e.g., incorrect descriptors 922). In some embodiments, the editable classification system 102, relies on the textual descriptors associated with the input image 902, not simply the class name. For example, the editable classification system 102, when provided with incorrect descriptors 922 and an input image 902 representing a “Blue Jay” bird, generates an updated predicted label 924 of “Least Tern” and an associated updated similarity score 926 of “0.0611.” The editable classification system 102, in various embodiments, generates an updated similarity score 926 of “0.0611” that indicates low similarity, reflecting both the reliance of the editable classification system 102 on the incorrect descriptors 922 and the recognition that the descriptors do not match the input image 902.

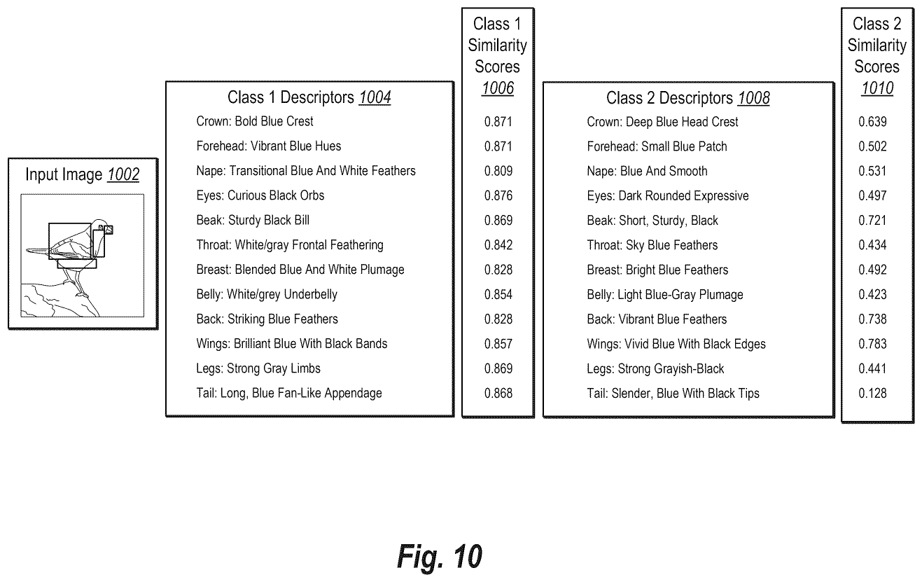

As previously discussed, the editable classification system 102 generates similarity scores for subsets of textual descriptors that relate to classes of a domain. In particular, the editable classification system 102 provides individual similarity scores for each textual descriptor of the subset of textual descriptors indicating similarity between the input image and the textual descriptors. FIG. 10 illustrates a diagram of the editable classification system 102 providing rationale (or reasoning) for rejecting a class in classifying a multi-part object in accordance with one or more embodiments.

As shown in FIG. 10, the editable classification system 102 generates a set of similarity scores for a first class (e.g., class 1 similarity scores 1006) for a subset of textual descriptors related to a first class (e.g., class 1 descriptors 1004). Additionally, in some cases, the editable classification system 102 generates a set of similarity scores for a second class (e.g., class 2 similarity scores 1010) for a subset of textual descriptors related to a second class (e.g., class 2 descriptors 1008). To determine a predicted classification (or predicted label) for the multi-part object of the input image 1002, the editable classification system 102, in some cases, compares similarity scores. For example, the editable classification system 102 generates multiple similarity scores and determines a predicted classification based on determining that the class 1 similarity scores 1006 (or average or sum of the similarity scores) are higher (or greater than) than the class 2 similarity scores 1010 (or average or sum of the similarity scores).

In various cases, the editable classification system 102 displays multiple class descriptors along with their associated similarity scores within a graphical user interface. In particular, in some embodiments, the editable classification system 102 displays the class with the highest similarity score and the class with the second highest similarity score and their associated textual descriptors within a graphical user interface. Additionally (or alternatively), in various embodiments, the editable classification system 102 displays the class with the highest similarity score and the class with the second highest similarity score and the similarity scores associated with their relevant subset of textual descriptors within the graphical user interface.

By displaying the classes, textual descriptors, and associated similarity scores of multiple classes, the editable classification system 102, in one or more embodiments, illustrates the rationale behind choosing one class over another (e.g., reasoning for rejecting) in generating a predicted classification. In particular, by displaying the subset of textual descriptors with similarity scores, the editable classification system 102, in various cases, indicates which textual descriptors of a non-selected class contributed to that class being not selected as the predicted classification.

As described above, in certain embodiments, the editable classification system 102 generates a new class to classify a multi-part object within a digital image. In particular, the editable classification system 102 generates a new class by facilitating the editing of textual descriptors within a graphical user interface. FIGS. 11A-11B illustrate diagrams of a graphical user interface classifying a multi-parti object according to user input in accordance with one or more embodiments.

As shown in FIG. 11A, the editable classification system 102 provides a graphical user interface 1100 for the editing of a predicted class 1104 of a multi-part object within an input image 1102. In some embodiments, the editable classification system 102 provides a graphical element (e.g., edit button 1108) that allows a user to edit the textual description 1106 associated with the closest known class. In various cases, the editable classification system 102 allows a user to edit text of the textual description 1106 to reflect the actual characteristics of the multi-part object of the input image 1102 by interacting with the graphical element and inserting a new textual description for a particular object part.

As shown in FIG. 11B, the editable classification system 102 provides a graphical user interface 1100 for saving a new class to a database of known classes. In one or more cases, the editable classification system 102, upon detected an edited or modified textual description 1110, allows a user to input a new for the new class 1112. For example, upon changing the textual descriptor related to object part “throat,” the editable classification system 102 provides an editable text box containing the predicted class name, allowing a user to input the new class 1112. In these or other embodiments, upon modifying the textual description, the editable classification system 102 provides a graphical user interface element allowing a user to save the new class to a known class database (e.g., new class button 1118). In some cases, the editable classification system 102 provides a graphical user interface element to recalculate the similarity score (e.g., similarity score button 1114) based on the modified textual description 1110 and/or the new class 1112. In some cases, the similarity score 1116 is provided in the graphical user interface 1100.

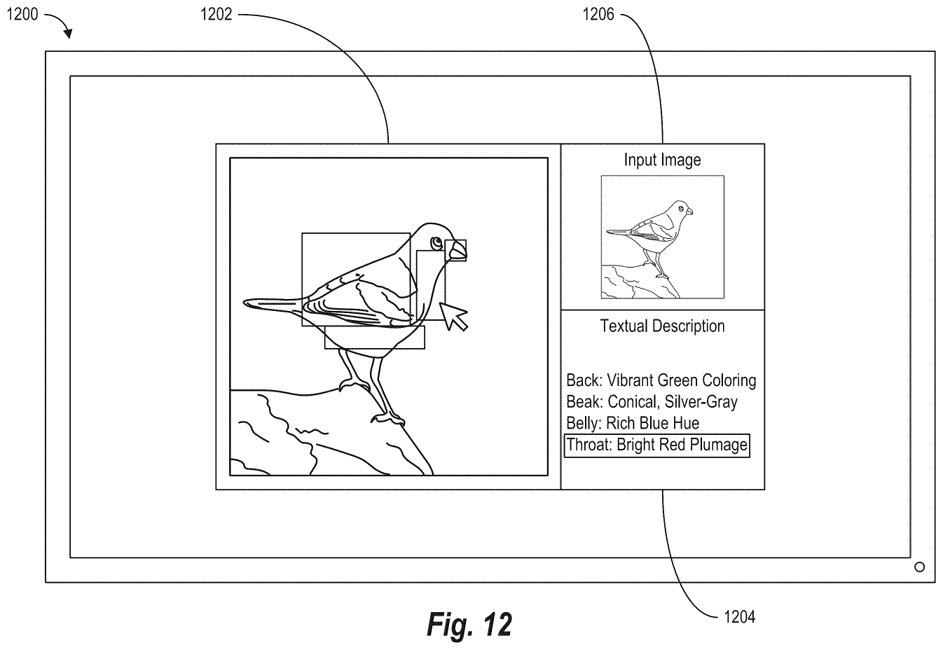

As previously described, the editable classification system 102, in various embodiments, generates bounding boxes linked to textual descriptors. In particular, in one or more cases, the editable classification system 102 provides a graphical user interface of the linked bounding boxes. FIG. 12 illustrates a diagram of a graphical user interface presenting bounding boxes linked to textual descriptors according to user input in accordance with one or more embodiments.

As shown in FIG. 12, the editable classification system 102, in various cases, provides a graphical user interface 1200 that includes an interactive image 1202 comprising bounding boxes. In one or more embodiments, the editable classification system 102, upon selection of an object part of the multi-part object within the interactive image 1202, highlights (or emphasizes) a textual descriptor of the textual description 1204 associated with the input image 1206. For example, the editable classification system 102, upon detection of a selection of the throat of a multi-part object within the interactive image 1202, emphasizes the throat textual description within the graphical user interface 1200. In these or other embodiments, the editable classification system 102, upon selection of a textual descriptor of the textual description 1204, emphasizes the relevant bounding box within the interactive image 1202. By emphasizing the linked textual descriptor/bounding box, the editable classification system 102 provides rationale behind the details of the classification of the input image 1206.

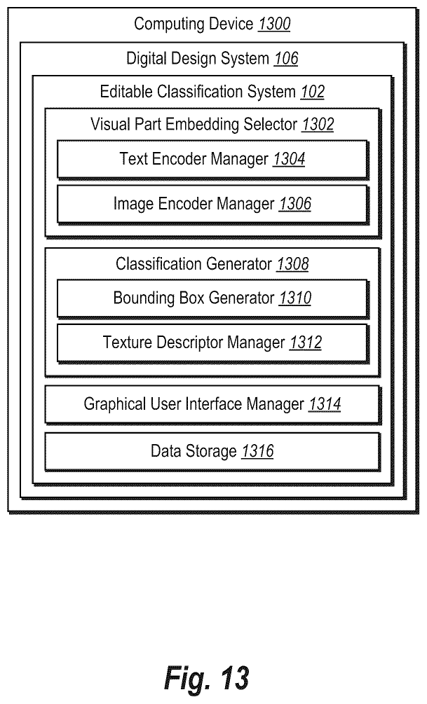

Looking now to FIG. 13, additional detail will be provided regarding components and capabilities of the editable classification system 102. Specifically, FIG. 13 illustrates an example schematic diagram of the editable classification system 102 on an example computing device 1300 (e.g., one or more of the client device 110 and/or the server device(s) 104). In some embodiments, the computing device 1300 refers to a distributed computing system where different managers are located on different devices, as described above. As shown in FIG. 13, the editable classification system 102 includes a visual part embedding selector 1302 including a text encoder manager 1304 and an image encoder manager 1306, a classification generator 1308 including a bounding box generator and a textual descriptors manager, a graphical user interface manager 1314, and data storage 1316.

As just mentioned, the editable classification system 102 includes a visual part embedding selector 1302 that selects, determines, identifies, generates, or maintains visual part embeddings that specify locations (e.g., groupings of pixels) of a digital image that correspond to object parts of a multi-part object within the digital image. Specifically, in some cases, the visual part embedding selector 1302 determines relationships between object part names and portions of a digital image comprising a multi-part object. In particular, the visual part embedding selector operates in conjunction with, or includes, the text encoder manager 1304. For example, the text encoder manager 1304 generates one or more text embeddings by utilizing a text encoder. In some embodiments, the text encoder manager 1304 takes an input text string listing object part names relevant to a multi-part object within a digital image and, via a text encoder, generates a set of text embeddings based on the object part names.

As shown, the visual part embedding selector 1302 also includes an image encoder manager 1306 that manages, maintains, determines, identifies, or generates digital image embeddings via an image encoder. In various cases, the image encoder manager 1306 operates in conjunction with text encoder manager 1304. For example, the image encoder manager 1306, by utilizing an image encoder, generates a set of patch embeddings from an input digital image. In some embodiments, by further utilizing linear projection, the image encoder manager 1306 generates a set of modified patch embeddings in the same dimension as text embeddings generated by a text encoder.

As further shown in FIG. 13, the editable classification system also includes a classification generator 1308 that generates a classification of a multi-part object within a digital image. For example, the classification generator 1308 generates similarity scores by comparing textual descriptors associated with a class to a multi-part object of a digital image. In various cases, the classification generator 1308 determines a classification for the multi-part object by comparing similarity scores that indicate relatedness to a previously known class.

As illustrated in FIG. 13, the classification generator 1308 includes a bounding box generator 1310 that manages, determines, generates, or identifies bounding boxes for display within a digital image. For instance, the bounding box generator 1310 utilizes a box neural network layer (e.g., a Box MLP) to generate a set of localized parts for display within the digital image. In some embodiments, the bounding box generator 1310, by utilizing the set of localized parts, generates an annotated image that visually displays bounding boxes, indicating groupings of pixels associated with object parts relevant to the multi-part object.

As also shown in FIG. 13, the classification generator 1308 also includes a textual descriptor manager 1312. In particular, in various cases, the textual descriptor manager 1312 manages, determines, generates, or identifies relationships between textual descriptors and a multi-part object. For example, the textual descriptor manager 1312, for a set of textual descriptors associated with a known classification, generates a similarity score for each of the textual descriptors of the set of textual descriptors indicating the relatedness of the multi-part object to the known classification (and/or each object part of the known classification). In some embodiments, the textual descriptor manager 1312, in conjunction with the classification generator 1308, generates a new (e.g., previously unknown) classification for the multi-part object based on the relationships between textual descriptors and the multi-part object within a digital image.

As further illustrated in FIG. 13, the editable classification system 102 also includes a graphical user interface manager 1314. In particular, the graphical user interface manager 1314 manages, maintains, generates, determines, or identifies user interactions with a graphical user interface. For example, the graphical user interface manager 1314 manages the editing of textual descriptor linked to bounding boxes of a multi-part object within a digital image. In some cases, the graphical user interface manager 1314 detects a modified textual descriptor and, in conjunction with the classification generator 1308 and/or the textual descriptor manager 1312, generates an updated classification (or new classification) for the multi-part object based on the modified textual descriptor.

As shown in FIG. 13, the editable classification system 102 also includes data storage 1316. The data storage 1316 operates in conjunction with, or includes, the visual part embedding selector 1302, the classification generator 1308 and/or the graphical user interface manager 1314. In some cases, the data storage 1316 manages the storage of data related to the classification of a digital image comprising a multi-part object. In various embodiments, the data storage 1316 makes various textual and image embeddings available for generating classifications of the multi-part object within a digital image. In one or more cases, the data storage 1316 communicates with the other components of the editable classification system 102 to facilitate the operations and functions described herein.

In one or more embodiments, each of the components of the editable classification system 102 are in communication with one another using any suitable communication technologies. Additionally, the components of the editable classification system 102 are in communication with one or more other devices including one or more client devices described above. It will be recognized that although the components of the editable classification system 102 are shown to be separate in FIG. 13, any of the subcomponents may be combined into fewer components, such as into a single component, or divided into more components as may serve a particular implementation. Furthermore, although the components of FIG. 13 are described in connection with the editable classification system 102, at least some of the components for performing operations in conjunction with the editable classification system 102 described herein may be implemented on other devices within the environment.

The components of the editable classification system 102, in one or more implementations, includes software, hardware, or both. For example, the components of the editable classification system 102 include one or more instructions stored on a computer-readable storage medium and executable by processors of one or more computing devices. When executed by the one or more processors, the computer-executable instructions of the editable classification system 102 cause the computing device 1300 to perform the methods described herein. Alternatively, the components of the editable classification system 102 comprises hardware, such as a special purpose processing device to perform a certain function or group of functions. Additionally, or alternatively, the components of the editable classification system 102 includes a combination of computer-executable instructions and hardware.

Furthermore, the components of the editable classification system 102 performing the functions described herein may, for example, be implemented as part of a stand-alone application, as a module of an application, as a plug-in for applications including content management applications, as a library function or functions that may be called by other applications, and/or as a cloud-computing model. Thus, the components of the editable classification system 102 may be implemented as part of a stand-alone application on a personal computing device or a mobile device. Alternatively, or additionally, the components of the editable classification system 102 may be implemented in any application that allows creation and delivery of marketing content to users, including, but not limited to, applications in ADOBE® CREATIVE CLOUD®, such as ADOBE® ACROBAT®, ADOBE® DOCUMENT CLOUD®, and ADOBE® EXPRESS®. “ADOBE,” “CREATIVE CLOUD,” “ACROBAT,” “DOCUMENT CLOUD,” and “EXPRESS”are either registered trademarks or trademarks of Adobe Inc. in the United States and/or other countries.

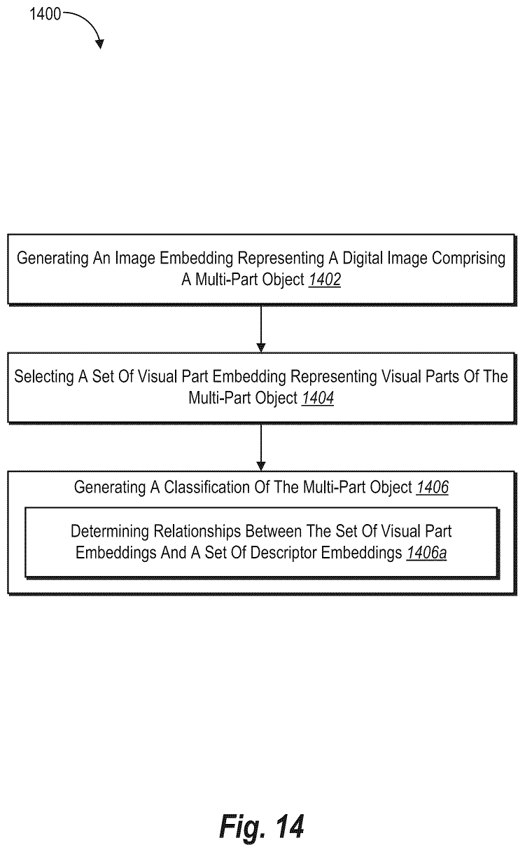

FIGS. 1-13, the corresponding text, and the examples provide a number of different systems, methods, and non-transitory computer readable media for determining a classification of a multi-part object. In addition to the foregoing, embodiments are describable in terms of flowcharts comprising acts for accomplishing a particular result. For example, FIG. 14 illustrates a flowchart of example sequences or series of acts in accordance with one or more embodiments.

While FIG. 14 illustrates acts according to particular embodiments, alternative embodiments may omit, add to, reorder, and/or modify any of the acts shown in FIG. 14. The acts of FIG. 14 are sometimes performed as part of a method. Alternatively, a non-transitory computer readable medium comprises instructions, that when executed by one or more processors, cause a computing device to perform the acts of FIG. 14. In still further embodiments, a system performs the acts of FIG. 14. Additionally, the acts described herein may be repeated or performed in parallel with one another or in parallel with different instances of the same or other similar acts.

FIG. 14 illustrates a flowchart of a series of acts 1400 for generating a classification of a multi-part object in accordance with one or more embodiments. In particular, the series of acts 1400 includes an act 1402 of generating an image embedding representing a digital image comprising a multi-part object. For example, the act 1402 involves generating, utilizing an image encoder, an image embedding representing a digital image comprising a multi-part object.

In addition, as illustrated in FIG. 14, the series of acts 1400 includes an act 1404 of selecting a set of visual part embeddings representing visual parts of the multi-part object. For example, the act 1404 involves selecting, from the image embedding, a set of visual part embeddings representing visual parts of the multi-part object that correspond to text embeddings representing names of a plurality of parts corresponding to the multi-part object.

As further illustrated in FIG. 14, the series of acts 1400 includes an act 1406 of generating a classification of the multi-part object. In particular, in some cases, the act 1406 involves generating, utilizing a part neural network layer with descriptor embedding matching, a classification of the multi-part object according to relationships between the set of visual part embeddings selected from the image embedding and a set of descriptor embeddings representing textual descriptions of the plurality of parts for the classification. In various embodiments, the act 1406 includes an act 1406a of determining relationships between the set of visual part embeddings and a set of descriptor embeddings.

In one or more embodiments, the series of acts 1400 includes an act of generating the classification of the multi-part object by determining a first similarity score for a first classification according to relationships between the set of visual part embeddings and a first subset of the set of descriptor embeddings. Additionally, the series of acts 1400 includes an act of determining a second similarity score for a second classification according to relationships between the set of visual part embeddings and a second subset of the set of descriptor embeddings. Furthermore, the series of acts 1400 includes an act of generating the classification of the multi-part object based on the first classification by determining that the first similarity score is greater than the second similarity score.

In certain embodiments, the series of acts 1400 includes an act of selecting a plurality of visual part embeddings representing visual parts of the multi-part object by determining cosine similarities between the text embeddings representing the names of the plurality of parts corresponding to the multi-part object and the image embedding. Additionally, the series of acts 1400 involves an act of selecting the plurality of visual part embeddings based on corresponding cosine similarities of the plurality of visual part embeddings relative to the text embeddings.

In some cases, the series of acts 1400 includes an act of generating, from the set of visual part embeddings utilizing a box neural network layer, a set of bounding boxes corresponding to the plurality of parts for display within the digital image.

In some embodiments, the series of acts 1400 includes an act of providing, for display within a graphical user interface, one or more of the textual descriptions of the plurality of parts for the classification linked to a set of bounding boxes corresponding to the plurality of parts. Additionally, the series of acts 1400 includes an act of generating modified textual descriptions by modifying one or more of the textual descriptions linked to the set of bounding boxes in response to an input via the graphical user interface. Further, the series of acts 1400 involves an act of generating an updated classification of the multi-part object according to updated relationships between the set of visual part embeddings and the modified textual descriptions of the plurality of parts for the classification, the updated classification within a database of known classifications.

In various cases, the series of acts 1400 includes an act of generating a modified digital image comprising a modified multi-part object by modifying one or more parts of the multi-part object within the digital image. Additionally, the series of acts 1400 includes an act of generating an updated classification of the modified multi-part object according to relationships between a set of visual part embeddings selected from an image embedding representing the modified digital image and a set of descriptor embeddings representing textual descriptions of a plurality of parts corresponding to the modified multi-part object.

In one or more cases, the series of acts 1400 includes an act of generating the classification of the multi-part object by determining, via one or more inputs to a graphical user interface, modified textual descriptions for a new classification by modifying one or more of the textual descriptions of the plurality of parts corresponding to the multi-part object. Additionally, the series of acts 1400 includes an act of adding a new classifier to a classifier neural network using the descriptor embedding matching using updated relationships between the set of visual part embeddings and the modified textual descriptions.

In some embodiments, the series of acts 1400 includes an act of selecting, from an image embedding representing a digital image comprising a multi-part object, a set of visual part embeddings representing visual parts of the multi-part object that correspond to text embeddings representing names of a plurality of parts corresponding to the multi-part object. Additionally, the series of acts 1400 includes an act of generating, from the set of visual part embeddings and utilizing a box neural network layer, a set of bounding boxes for display within the digital image indicating the plurality of parts corresponding to the multi-part object. Further, the series of acts 1400 includes an act of generating, utilizing a part neural network layer with descriptor embedding matching, a classification of the multi-part object according to relationships between the set of visual part embeddings selected from the image embedding and a set of descriptor embeddings representing textual descriptions of the plurality of parts for the classification.

In various cases, the series of acts 1400 includes an act of generating the classification of the multi-part object by determining a plurality of similarity scores indicating the relationships between the set of descriptor embeddings representing the textual descriptions of the plurality of parts and the set of visual part embeddings. Additionally, the series of acts 1400 includes an act of generating, from an overall similarity score based on the plurality of similarity scores, the classification of the multi-part object.

In some embodiments, the series of acts 1400 includes an act of generating the set of bounding boxes for display within the digital image comprises determining a set of pixels of the digital image corresponding to the set of visual part embeddings.

In one or more embodiments, the series of acts 1400 includes an act of generating, in response to an input via a graphical user interface displaying the digital image, a modified textual description of the textual descriptions by editing a text of a textual description of the textual descriptions. Additionally, the series of acts 1400 includes an act of determining an updated classification of the multi-part object in response to the modified textual description.

In some cases, the series of acts 1400 includes an act of generating the classification of the multi-part object by determining a first similarity score for a first classification by determining a first dot product between the set of visual part embeddings and a first subset of the set of descriptor embeddings. Additionally, the series of acts 1400 includes an act of determining a second similarity score for a second classification by determining a second dot product between the set of visual part embeddings and a second subset of the set of descriptor embeddings by. Further, the series of acts 1400 includes an act of generating the classification of the multi-part object based on the first similarity score by determining that the first similarity score is greater than the second similarity score.

In one or more embodiments, the series of acts 1400 includes an act of selecting a set of visual part embeddings by determining a set of patch embeddings indicating a grouping of pixels of the digital image representing visual parts of the multi-part object that correspond to the text embeddings representing the names of a plurality of parts corresponding to the multi-part object. Additionally, the series of acts 1400 includes an act of selecting, by utilizing a linear projection layer, a set of visual part embeddings in a dimension of the text embeddings from the set of patch embeddings.

In various cases, the series of acts 1400 includes an act of providing, in response to an input within a graphical user interface indicating selection of one or more of the plurality of parts, one or more of the textual descriptions representing the one or more of the plurality of parts for display within the graphical user interface.

In some embodiments, the series of acts 1400 includes an act of providing, for display within a graphical user interface, one or more of the textual descriptions of the plurality of parts indicating a reasoning for rejecting a second classification.

In one or more cases, the series of acts 1400 includes an act of selecting, from an image embedding representing a digital image comprising a multi-part object, a set of visual part embeddings representing visual parts of the multi-part object that correspond to text embeddings representing names of a plurality of parts corresponding to the multi-part object. Additionally, the series of acts 1400 includes an act of determining relationships between the set of visual part embeddings selected from the image embedding and a set of descriptor embeddings comprising textual descriptions of the plurality of parts for a classification. Further, the series of acts 1400 includes an act of providing, for display within a graphical user interface, one or more of the textual descriptions of the plurality of parts for the classification linked to one or more of a set of bounding boxes corresponding to the plurality of parts.

In some embodiments, the series of acts 1400 includes an act of generating, via the graphical user interface, a modified textual description of the textual descriptions by editing a text of a textual description of the textual descriptions. Additionally, the series of acts 1400 involves determining an updated classification of the multi-part object based on the modified textual description by adding a new classification with corresponding textual descriptions in response to edited textual descriptions of the classification within the graphical user interface.

In one or more cases, the series of acts 1400 includes an act of determining relationships between the set of visual part embeddings and the set of descriptor embeddings by generating a set of unnormalized distances between the digital image and a plurality of possible classifications for the set of descriptor embeddings by determining a dot product between the set of visual part embeddings and the set of descriptor embeddings. Additionally, the series of acts 1400 includes an act of determining relationships between the set of visual part embeddings and the set of descriptor embeddings. Further, the series of acts 1400 includes an act of generating a plurality of similarity scores for the plurality of classifications based on the set of unnormalized distances. In addition, the series of acts 1400 includes an act of determining, from the plurality of similarity scores, the relationships between the set of visual part embeddings and the set of descriptor embeddings.

In various embodiments, the series of acts 1400 includes an act of determining relationships between the set of visual part embeddings by generating, utilizing a part neural network layer with descriptor embedding matching, a classification of the multi-part object according to relationships between the set of visual part embeddings selected from the image embedding and a set of descriptor embeddings comprising textual descriptions of the plurality of parts for the classification.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media. Non-transitory computer-readable storage media (devices) includes optical and/or non-optical memory, disks, or caches that store computer data interpretable by one or more processors to execute particular functions as described herein. A “network” is defined as one or more data links that enable the transport of electronic data between computer systems and/or modules and/or other electronic devices. Information is transferred or provided over a network (either hardwired, wireless, or a combination of hardwired or wireless) to a computer to carry program code in the form of computer-executable instructions or data structures and which can be accessed by a general purpose or special purpose computer.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code.

Embodiments of the present disclosure can also be implemented in cloud computing environments. In this description, “cloud computing” is defined as a model for enabling on-demand network access to a shared pool of configurable computing resources. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth.

FIG. 15 illustrates, in block diagram form, an example computing device 1500 (e.g., the computing device 1500, the client device 110, and/or the server device(s) 104) that may be configured to perform one or more of the processes described above. As shown by FIG. 15, the computing device can comprise a processor(s) 1502, memory 1504, a storage device 1506, an I/O interface 1508, and a communication interface 1510.

In particular embodiments, processor(s) 1502 includes hardware for executing instructions, such as those making up a computer program. As an example, and not by way of limitation, to execute instructions, processor(s) 1502 may retrieve (or fetch) the instructions from an internal register, an internal cache, memory 1504, or a storage device 1506 and decode and execute them. The computing device 1500 includes memory 1504, which is coupled to the processor(s) 1502. The memory 1504 may be used for storing data, metadata, and programs for execution by the processor(s). The memory 1504 may include one or more of volatile and non-volatile memories. The memory 1504 may be internal or distributed memory. The computing device 1500 includes a storage device 1506 includes storage for storing data or instructions. As an example, and not by way of limitation, storage device 1506 can comprise a non-transitory storage medium described above. The computing device 1500 also includes one or more input or output (“I/O”) devices/interfaces 1508, which are provided to allow a user to provide input to (such as user strokes), receive output from, and otherwise transfer data to and from the computing device 1500. These I/O devices/interfaces 1508 may include a mouse, keypad or a keyboard, a touch screen, camera, optical scanner, network interface, modem, other known I/O devices or a combination of such I/O devices/interfaces 1508.

The computing device 1500 can further include a communication interface 1510. The communication interface 1510 can include hardware, software, or both. The communication interface 1510 can provide one or more interfaces for communication (such as, for example, packet-based communication) between the computing device and one or more other computing devices (e.g., computing device 1500) or one or more networks. The computing device 1500 can further include a bus 1512. The bus 1512 can comprise hardware, software, or both that couples components of computing device 1500 to each other.

What is claimed is:

1. A computer-implemented method comprising:
generating, utilizing an image encoder, an image embedding representing a digital image comprising a multi-part object;
selecting, from the image embedding, a set of visual part embeddings representing visual parts of the multi-part object that correspond to text embeddings representing names of a plurality of parts corresponding to the multi-part object; and
generating, utilizing a part neural network layer with descriptor embedding matching, a classification of the multi-part object according to relationships between the set of visual part embeddings selected from the image embedding and a set of descriptor embeddings representing textual descriptions of the plurality of parts for the classification.

2. The computer-implemented method of claim 1, wherein generating the classification of the multi-part object comprises:
determining a first similarity score for a first classification according to relationships between the set of visual part embeddings and a first subset of the set of descriptor embeddings;
determining a second similarity score for a second classification according to relationships between the set of visual part embeddings and a second subset of the set of descriptor embeddings; and
generating the classification of the multi-part object based on the first classification by determining that the first similarity score is greater than the second similarity score.

3. The computer-implemented method of claim 1, wherein selecting a plurality of visual part embeddings representing visual parts of the multi-part object comprises:
determining cosine similarities between the text embeddings representing the names of the plurality of parts corresponding to the multi-part object and the image embedding; and
selecting the plurality of visual part embeddings based on corresponding cosine similarities of the plurality of visual part embeddings relative to the text embeddings.

4. The computer-implemented method of claim 1, further comprising generating, from the set of visual part embeddings utilizing a box neural network layer, a set of bounding boxes corresponding to the plurality of parts for display within the digital image.

5. The computer-implemented method of claim 1, further comprising providing, for display within a graphical user interface, one or more of the textual descriptions of the plurality of parts for the classification linked to a set of bounding boxes corresponding to the plurality of parts.

6. The computer-implemented method of claim 5, further comprising:
generating modified textual descriptions by modifying one or more of the textual descriptions linked to the set of bounding boxes in response to an input via the graphical user interface; and
generating an updated classification of the multi-part object according to updated relationships between the set of visual part embeddings and the modified textual descriptions of the plurality of parts for the classification, the updated classification within a database of known classifications.

7. The computer-implemented method of claim 1, wherein generating the classification of the multi-part object comprises:
determining, via one or more inputs to a graphical user interface, modified textual descriptions for a new classification by modifying one or more of the textual descriptions of the plurality of parts corresponding to the multi-part object; and
adding a new classifier to a classifier neural network using the descriptor embedding matching using updated relationships between the set of visual part embeddings and the modified textual descriptions.

8. A system comprising:
one or more memory devices; and
one or more processors coupled to the one or more memory devices that cause the system to perform operations comprising:
selecting, from an image embedding representing a digital image comprising a multi-part object, a set of visual part embeddings representing visual parts of the multi-part object that correspond to text embeddings representing names of a plurality of parts corresponding to the multi-part object;
generating, from the set of visual part embeddings and utilizing a box neural network layer, a set of bounding boxes for display within the digital image indicating the plurality of parts corresponding to the multi-part object; and
generating, utilizing a part neural network layer with descriptor embedding matching, a classification of the multi-part object according to relationships between the set of visual part embeddings selected from the image embedding and a set of descriptor embeddings representing textual descriptions of the plurality of parts for the classification.

9. The system of claim 8, wherein generating the classification of the multi-part object comprises:
determining a plurality of similarity scores indicating the relationships between the set of descriptor embeddings representing the textual descriptions of the plurality of parts and the set of visual part embeddings; and
generating, from an overall similarity score based on the plurality of similarity scores, the classification of the multi-part object.

10. The system of claim 8, wherein generating the set of bounding boxes for display within the digital image comprises determining a set of pixels of the digital image corresponding to the set of visual part embeddings.

11. The system of claim 8, further comprising:
generating, in response to an input via a graphical user interface displaying the digital image, a modified textual description of the textual descriptions by editing a text of a textual description of the textual descriptions; and
determining an updated classification of the multi-part object in response to the modified textual description.

12. The system of claim 8, wherein generating the classification of the multi-part object comprises:
determining a first similarity score for a first classification by determining a first dot product between the set of visual part embeddings and a first subset of the set of descriptor embeddings;
determining a second similarity score for a second classification by determining a second dot product between the set of visual part embeddings and a second subset of the set of descriptor embeddings by; and
generating the classification of the multi-part object based on the first similarity score by determining that the first similarity score is greater than the second similarity score.

13. The system of claim 8, wherein selecting a set of visual part embeddings comprises:
determining a set of patch embeddings indicating a grouping of pixels of the digital image representing visual parts of the multi-part object that correspond to the text embeddings representing the names of a plurality of parts corresponding to the multi-part object; and
selecting, by utilizing a linear projection layer, a set of visual part embeddings in a dimension of the text embeddings from the set of patch embeddings.

14. The system of claim 8, further comprising providing, in response to an input within a graphical user interface indicating selection of one or more of the plurality of parts, one or more of the textual descriptions representing the one or more of the plurality of parts for display within the graphical user interface.

15. The system of claim 8, further comprising providing, for display within a graphical user interface, one or more of the textual descriptions of the plurality of parts indicating a reasoning for rejecting a second classification.

16. A non-transitory computer-readable medium storing instructions thereon that, when executed by at least one processor, cause the at least one processor to perform operations comprising:
selecting, from an image embedding representing a digital image comprising a multi-part object, a set of visual part embeddings representing visual parts of the multi-part object that correspond to text embeddings representing names of a plurality of parts corresponding to the multi-part object;
determining relationships between the set of visual part embeddings selected from the image embedding and a set of descriptor embeddings comprising textual descriptions of the plurality of parts for a classification; and
providing, for display within a graphical user interface, one or more of the textual descriptions of the plurality of parts for the classification linked to one or more of a set of bounding boxes corresponding to the plurality of parts.

17. The non-transitory computer-readable medium of claim 16, further comprising:
generating, via the graphical user interface, a modified textual description of the textual descriptions by editing a text of a textual description of the textual descriptions; and
determining an updated classification of the multi-part object based on the modified textual description by adding a new classification with corresponding textual descriptions in response to edited textual descriptions of the classification within the graphical user interface.

18. The non-transitory computer-readable medium of claim 16, wherein determining relationships between the set of visual part embeddings and the set of descriptor embeddings comprises:
generating a set of unnormalized distances between the digital image and a plurality of possible classifications for the set of descriptor embeddings by determining a dot product between the set of visual part embeddings and the set of descriptor embeddings; and
determining relationships between the set of visual part embeddings and the set of descriptor embeddings.

19. The non-transitory computer-readable medium of claim 18, wherein determining a relationship between the set of visual part embeddings and the set of descriptor embeddings further comprises:
generating a plurality of similarity scores for the plurality of classifications based on the set of unnormalized distances; and
determining, from the plurality of similarity scores, the relationships between the set of visual part embeddings and the set of descriptor embeddings.

20. The non-transitory computer-readable medium of claim 16, wherein determining relationships between the set of visual part embeddings comprises generating, utilizing a part neural network layer with descriptor embedding matching, a classification of the multi-part object according to relationships between the set of visual part embeddings selected from the image embedding and a set of descriptor embeddings comprising textual descriptions of the plurality of parts for the classification.
